(19) United States
(12) Patent Application Publication
(10) Pub. No.: US 2015/0014232 A1
(43) Pub. Date: Jan. 15, 2015

(54) MEMBRANE MODULES

(71) Applicants: Robert L. McGinnis, Coventry, CT (US); Aaron Mandell, Healdsburg, CA (US); Richard Stover, Newton, MA (US)

(72) Inventors: Robert L. McGinnis, Coventry, CT (US); Aaron Mandell, Healdsburg, CA (US); Richard Stover, Newton, MA (US)

(73) Assignee: OASYS WATER, INC., Boston, MA (US)

(21) Appl. No.: 14/238,093

(22) PCT Filed: Aug. 8, 2012
(86) PCT No.: PCT/US2012/049960

§ 371 Date: Sep. 10, 2014

Related U.S. Application Data
(60) Provisional application No. 61/521,871, filed on Aug. 10, 2011.

(51) Int. Cl. B01D 63/10; B01D 61/36; B01D 63/08

(52) U.S. Cl. CPC B01D 63/10; B01D 63/08; B01D 61/364
USPC 210/180; 210/321.75; 210/184; 210/321.83

(57) ABSTRACT

The invention relates to membrane modules and applications therefor. In particular, the invention relates to the construction of membrane modules for use in forward osmosis, heat exchange, and distillation processes.

### FIELD OF THE INVENTION

The invention generally relates to membrane modules and more particular the manufacture and arrangement of membrane modules and uses therefor.

### BACKGROUND

Membrane-based fluid separation systems (for example, osmosis and pervaporation) are generally known in the prior art. Typically, these systems include a number of components that are plumbed together, which can increase the complexity and overall size of the systems. Additionally, needing to plumb the various components together results in the need for still more components (e.g., valves, fittings, etc.) and results in additional drawbacks for such systems (e.g., additional component costs and plumbing leaks).

Furthermore, those conventional systems tend to be arranged for single applications (e.g., a single pass or type of process). So in cases where multiple processes need to be performed and/or additional stages of a single type of process are desired, additional componentry and plumbing is required, again adding to the complexity and size of the systems. Specifically, multiple modules would need to be plumbed in series and/or parallel to suit a particular application, and once constructed, would not be easy to modify to, for example, accommodate a change in the system's requirements or repair a defect.

### SUMMARY

Accordingly, it may be desirable to integrate multiple membrane-based processes into single modules to reduce plumbing and the overall size of the systems. The various membrane modules of the present invention allow for the manufacture and arrangement of a variety of membrane-based systems into single, simplified modules that are easily assembled, minimize plumbing, and result in smaller overall footprints. The modularized nature of these membrane modules further provide for the interchangeability of membranes and/or membrane assemblies facilitating maintenance, repair, and/or customization of the modules.

In one aspect, the invention relates to a membrane module including a plurality of first membrane plates, a plurality of second membrane plates, a plurality of membrane sheets, and first and second cover plates. Each membrane plate includes an interlocking mechanism disposed about at least a portion of a periphery thereof and defining an inlet, an outlet, and a flow path therebetween and a planar surface defining an opening formed therein. At least one membrane sheet is disposed on the planar surface of each of the first and second membrane plates and corresponds to the openings formed therein. The plurality of first and second membrane plates are secured to one another via their interlocking mechanisms and arranged in an alternating pattern. The first cover plate is disposed below the assembled membrane plates and secured to at least one of the membrane plates and the second cover plate is disposed above the assembled membrane plates and secured to at least one of the membrane plates.

In another aspect, the invention relates to a membrane module including a plurality of membrane plates, a plurality of membrane sheets and first and second cover plates. Each membrane plate includes an elongate body having a first end, a second end, and a substantially planar surface that defines a generally centrally located opening, a first inlet formed in the substantially planar surface and disposed proximate the first end of the elongate body, a first outlet formed in the substantially planar surface and disposed proximate the second end of the elongate body, a second inlet formed in the substantially planar surface, a second outlet formed in the substantially planar surface, a first interlocking mechanism disposed about at least a portion of a periphery of a first side of the elongate body and defining a first flow path between the first inlet and the first outlet, and a second interlocking mechanism disposed about at least a portion of the periphery of a second side of the elongate body and defining a second flow path between the second inlet and the second outlet. At least one membrane sheet is disposed on each of the membrane plates and corresponds to the openings defined by the planar surfaces thereof. The plurality of membrane plates are secured to each other via the interlocking mechanisms and arranged 180° out of phase in an alternating pattern, such that alternating first inlets and first outlets are in fluid communication and alternating second inlets and second outlets are in fluid communication and the first and second flow paths alternate consecutively. The first cover plate is disposed below the assembled membrane plates and secured to at least one of the membrane plates and the second cover plate is disposed above the assembled membrane plates and secured to at least one of the membrane plates. In one embodiment, the second inlet is disposed proximate the first end of the elongate body and the second outlet is disposed proximate the second end of the elongate body. In another embodiment, the second inlet is disposed proximate the second end of the elongate body and the second outlet is disposed proximate the first end of the elongate body.

In various embodiments of the foregoing aspects, the membrane module includes at least one manifold assembly secured to the assembled membrane plates to direct at least two process streams into and out of the membrane module via the first and second inlets and outlets. In some embodiments, the at least one manifold assembly includes a first manifold assembly disposed on at least one of the cover plates and in fluid communication with the first and second inlets of the membrane plates and a second manifold assembly disposed on at least one of the cover plates and in fluid communication with first and second outlets of the membrane plates. The membrane modules can include additional inlets and outlets to accommodate multiple process streams and any number of manifold assemblies can be used to accommodate same.

Alternatively or additionally, a membrane module assembly can include a housing having first and second inlets and first and second outlets, where the membrane module is disposed within the housing such that the first inlet and the first outlet of the housing are in fluid communication with the first membrane plate inlets and the first membrane plate outlets and the second inlet and the second outlet of the housing are in fluid communication with the second membrane plate inlets and the second membrane plate outlets. In one or more embodiments, the housing can be made of a flexible or otherwise expandable material. A flexible housing may be desirable in applications where the membrane module is submerged and fluids may be “bubbled” through the module. The membrane modules can also include a plurality of mesh sheets, where at least one mesh sheet is disposed between adjacent membrane plates, for example, pairs of first and second membrane plates. The first and second cover plates can be secured to one another via mechanical fasteners, thereby clamping the assembly of first and second membrane plates. In some embodiments, the first and second membrane plates can have top and bottom surfaces and interlocking mechanisms disposed on both the top and bottom surfaces of each membrane plate.

In additional embodiments, each of the plurality of membrane plates can include a polymeric material. The plurality of membrane sheets can include one or more of forward osmosis membranes, heat exchange membranes, contact membranes, evaporator membranes, condenser membranes, and absorber membranes. In one embodiment, each of the forward osmosis membranes comprises a feed side and a permeate side that are oriented on the membrane plates such that for any two adjacent membrane plates, either the permeate sides are facing each other or the feed sides are facing each other. In another embodiment, a plurality of heat exchange membranes are disposed on the plurality of first membrane plates and a plurality of contact membranes are disposed on the plurality of second membrane plates. Alternatively, a plurality of heat exchange membranes and a plurality of contact membranes can be disposed on the membrane plates in an alternating manner.

In another aspect, the invention relates to a membrane module including a plurality of first and second membrane plates, a plurality of heat exchange membranes, and a plurality of contact membranes. Each of the membrane plates has an inlet, an outlet and an opening formed in a planar surface thereof. At least one heat exchange membrane is secured to each of the first membrane plates and oriented to cover the opening formed in the planar surface thereof. At least one contact membrane is secured to each of the second membrane plates and oriented to cover the opening formed in the planar surface thereof. The first and second membrane plates are assembled in an alternating manner; however, other arrangements are contemplated and within the scope of the invention.

In various embodiments, the first membrane plate inlets are in fluid communication, the first membrane plate outlets are in fluid communication, the second membrane plate inlets are in fluid communication, and/or the second membrane plate outlets are in fluid communication. In some embodiments, the first and second membrane plates are identical and define longitudinally asymmetrical flow paths between their respective inlets and outlets. In various embodiments, the module is disposed within a housing having ports that interface with the inlets and outlets of the membrane plates. In other embodiments, the module can include additional membrane plates and types of membranes to accommodate additional process streams. The module may also include membrane plates including insulating materials or blank membrane plates to create different flow paths within the module. These additional membranes and/or membrane plates can include or be manufactured from materials that can assist the various processes taking place within the module. For example, a plate made of a highly conductive metal can be used to siphon heat out of the system. In another example, a membrane and/or membrane plate can be coated with a catalyst to assist in a chemical reaction, such as accelerating the absorption of draw solutes.

In another aspect, the invention relates to a method of manufacturing a membrane module. The method includes the steps of providing a first membrane plate defining an asymmetrical flow path terminating with an inlet and an outlet and an opening formed in a planar surface of the membrane plate, securing a first membrane sheet on the planar surface and over the opening formed therein, providing a second membrane plate defining an asymmetrical flow path terminating with an inlet and an outlet and an opening formed in a planar surface of the membrane plate, securing a second membrane sheet on the planar surface of the second membrane plate and over the opening formed therein, and attaching the second membrane plate to the first membrane plate, wherein the asymmetrical flow paths of the first and second membrane plates are disposed 180 degrees out of phase. The method includes repeating the foregoing steps as many times as necessary to construct a membrane module having a set number of plates (i.e., layers). The specific number of layers will be selected to suit a particular application and to achieve a desired result, for example, X gallons a day of solvent passed through a forward osmosis membrane module. In various embodiments, the first and second membrane sheets can include, for example, forward osmosis membranes, heat exchange membranes, and contact membranes. The method can also include providing a third membrane plate, securing a third membrane sheet to the third membrane plate and attaching the third membrane plate to either the first or second membrane plate to accommodate additional process streams. The method can also include attaching top and bottom cover plates to the assembled membrane plates or disposing the membrane module within a housing.

In another aspect, the invention relates to a spiral wound membrane module including a center tube, a membrane assembly, and an end tube. The center tube has an elongate body defining an inlet and an inner lumen. The membrane assembly defines an inner surface and an outer surface, where the inner surface is in fluid communication with the inner lumen of the center tube. The end tube has an elongate body defining an outlet and an inner lumen, where the inner lumen of the end tube is in fluid communication with the inner surface of the membrane assembly. The module can also include a housing having an inlet and an outlet and defining a chamber for receiving the center tube, the membrane assembly, and the end tube. The housing chamber is in fluid communication with the outer surface of the membrane assembly and is in fluidic isolation from the center tube inlet and the end tube outlet.

These and other objects, along with advantages and features of the present invention herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention and are not intended as a definition of the limits of the invention. For purposes of clarity, not every component may be labeled in every drawing. In the following description, various embodiments of the present invention are described with reference to the following drawings, in which:

FIG. 1 is a perspective view of membrane module assembly in accordance with one or more embodiments of the invention;

FIGS. 2A and 2B are end and side views of the membrane module of FIG. 1 in partial cross-section;

FIGS. 3A-3C are plan views of various configurations of membrane plates for use in the membrane module of FIG. 1;

FIG. 3D is a perspective view of an alternative configuration of a membrane plate for use in the membrane module of FIG. 1;

FIG. 3E is schematic plan view of the plates of FIGS. 3A and 3D;

FIG. 3F is a perspective view of an alternative manner of assembling the membrane module of FIG. 1;

FIGS. 4A-4M are various views of the assembly details of certain aspects of the membrane modules in accordance with one or more embodiments of the invention;

FIG. 5 is a schematic representation of the operation of a membrane module in accordance with one or more embodiments of the invention;

FIG. 6A is a perspective view of an alternative membrane module in accordance with one or more embodiments of the invention;

FIG. 6B is a partially exploded perspective view of an alternative embodiment of the membrane module of FIG. 6A;

FIG. 6C is an exploded perspective view of an alternative embodiment of the membrane module of FIG. 6A;

FIG. 7A is a plan view of one embodiment of a membrane plate for use in the membrane modules of FIGS. 6A and 6B;

FIG. 7B is a plan view of the orientation of two adjacent, alternating membrane plates;

FIG. 7C is an enlarged view of a portion of the membrane plate of FIG. 7A;

FIGS. 8-10 are schematic representations of alternative configurations and operations of membrane modules in accordance with one or more embodiments of the invention;

FIG. 11A is a schematic representation of a vapor absorption cycle that may be carried out with one of the membrane modules disclosed herein;

FIG. 11B is a schematic representation of a membrane vapor absorption cycle module in accordance with one or more embodiments of the invention;

FIG. 12A is a plan view of a prior art spiral wound membrane module in an unwound configuration;

FIGS. 12B-12E are various views of a spiral wound membrane module in accordance with one or more embodiments of the invention; and

FIGS. 13A-13C are various views of an alternative membrane module assembly.

### DETAILED DESCRIPTION

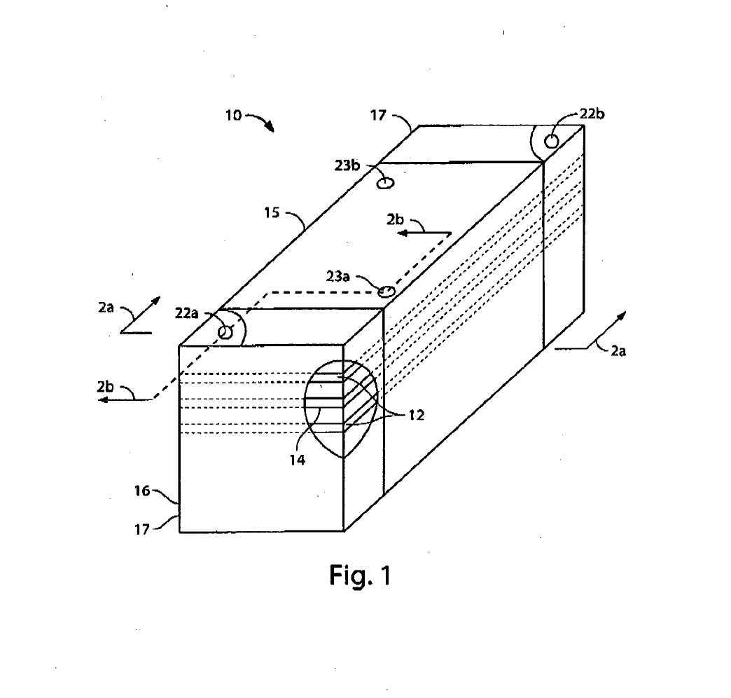

FIG. 1 depicts a perspective view of a membrane module 10 in accordance with one or more embodiments of the invention. The module 10 has a plate and frame type of arrangement and includes a housing 16 and a plurality of membrane plates 12, 14 disposed therein. It is noted that there may be two or more different membrane plate configurations included in any given module to direct the flow of multiple streams through the module; however, the membrane plates may also differ in type to perform different functions depending on the use of the module. For example, modules can include any combination of osmosis membranes, vapor contact membranes, and heat exchange membranes. In one embodiment, the housing 16 includes a central body 15 and bulkheads 17 disposed at each end of the body 15. As shown in FIG. 1, the housing 16 has a substantially rectangular shape; however, other shapes are contemplated and considered within the scope of the invention, for example, cylindrical with domed bulkheads, similar to a typical pressure vessel. The body 15 and bulkheads 17 can be assembled via any known mechanical means, e.g., welded, threaded, or flanged connections. In the case of a threaded connection, the bulkheads 17 can be removed from the body 15 to perform maintenance on the membrane stack (e.g., replace an individual membrane plate) or replace with an alternative bulkhead with, for example, an alternative porting arrangement.

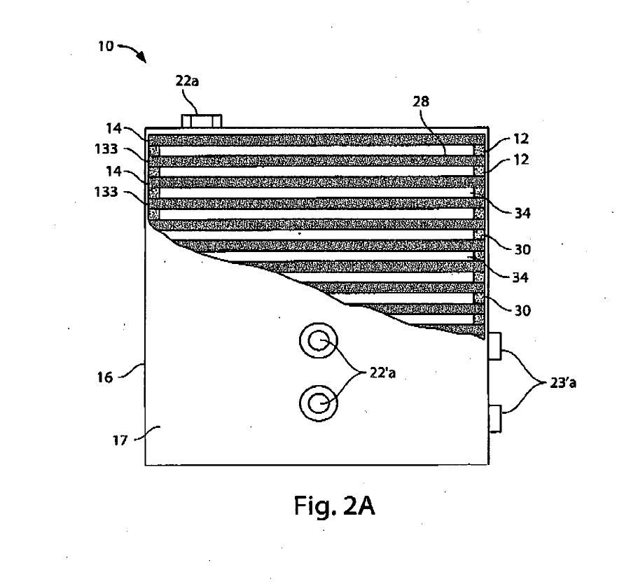

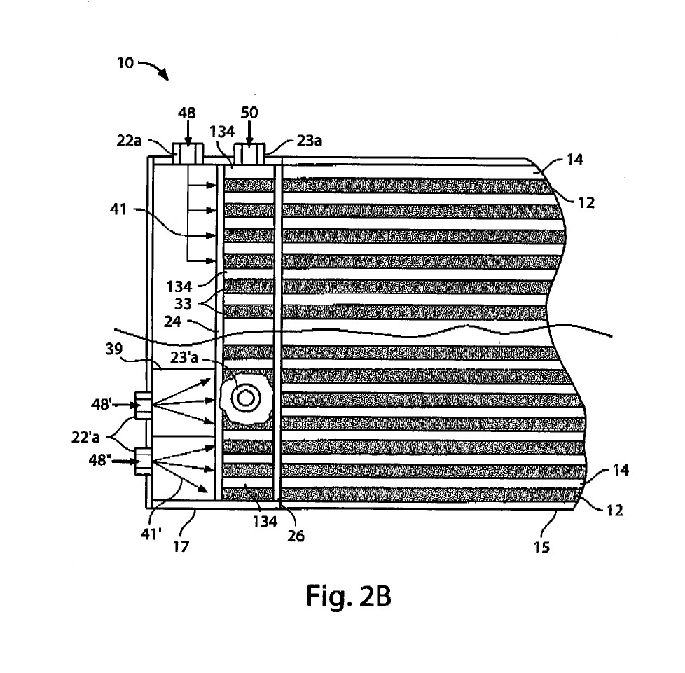

The membrane plates 12, 14 include complimentary shapes and flow paths, as discussed below, and are arranged in an alternating fashion to direct different process streams along predetermined flow paths. The bulkheads 17 and body 15 include a plurality of ports 22, 23 providing inlets and outlets for the various flows. As shown in FIG. 1, the module 10 includes an inlet 22a and an outlet 22b for a first process stream and an inlet 23a and an outlet 23b for a second process stream. In the embodiment shown, the inlets 22a, 23a and outlets 22b, 23b are located in the same general end of the module 10, such that the process streams will flow in the same direction; however, the location of the inlets/outlets for either stream can be reversed to provide a counter flow between the two streams. In some embodiments, the body 15 and/or bulkheads 17 can include additional ports for accommodating additional process streams or for maintenance purposes (e.g., introducing air or a cleaning solution). The ports can be, for example, threaded, flanged, or fitted with quick disconnect fittings. One example of an arrangement of membrane plates 12, 14 and ports 22, 23 is shown in FIGS. 2A and 2B.

FIG. 2A depicts an end view of the membrane module 10 of FIG. 1 with a portion of one bulkhead 17 removed to illustrate the membrane plate arrangement. FIG. 2B depicts a partial side view of the membrane module 10 in cross-section. As can be seen, the module 10 includes alternating membrane plates 12, 14 secured within the housing, either directly or via end plates 24, 26. The membrane module 10 shown includes two inner end plates 26 and two outer end plates 24, which are sealed to the housing 16 and/or bulkhead 17 about their periphery. For example, in one embodiment, the inner end plates 26 can be sealed to the end openings 19 of the body 15 of the housing 16 and include openings through which the various membrane plates 12, 14 pass. The membrane plates are sealed (e.g., via welding or other mechanical means so that a gas or liquid (e.g., an aqueous or non-aqueous solution) can only flow between particular membrane plates as determined by ports in the housing body 15 and/or bulkheads 17 and the membrane plate porting. In one or more embodiments, the outer end plates 24 can be disposed within the bulkheads 17 and sealed about their peripheries therein. The outer end plates 24 can also include openings that allow the membrane plates to pass therethrough. The membrane plates also sealingly engage the outer end plates 24 so as to direct the flow of a liquid or gas between particular membrane plates based on the porting in the bulkheads 17 and the membrane plate porting. In alternative embodiments, additional end plates can be used in conjunction with additional ports to direct more than two different flows through the membrane module 10.

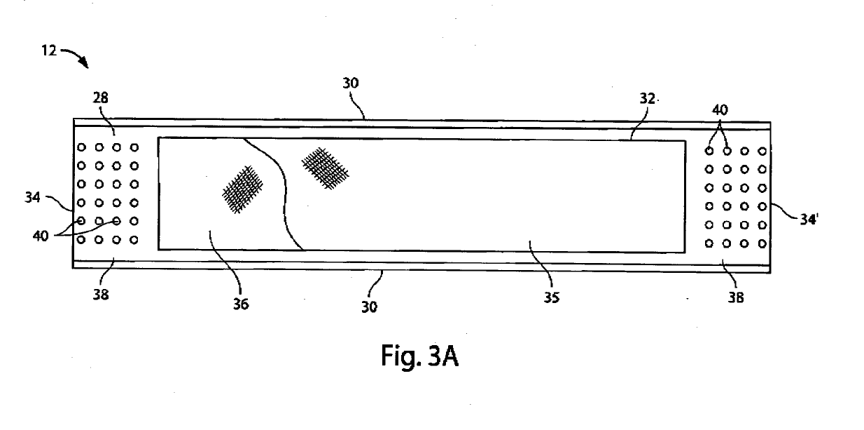

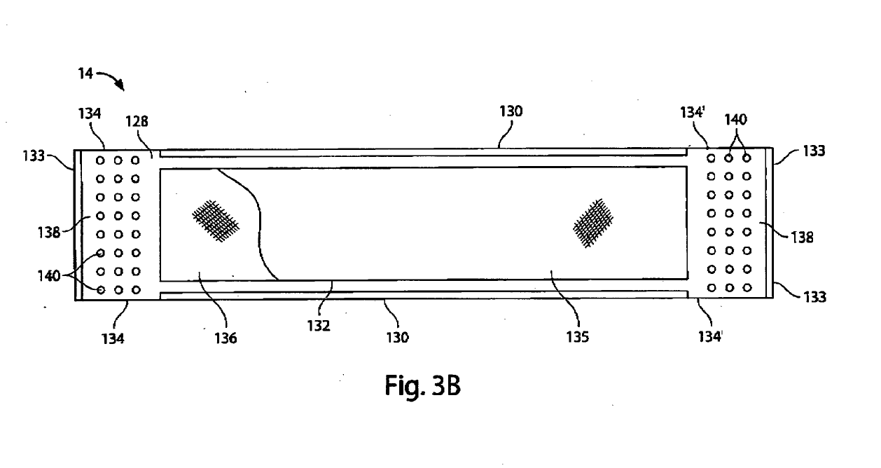

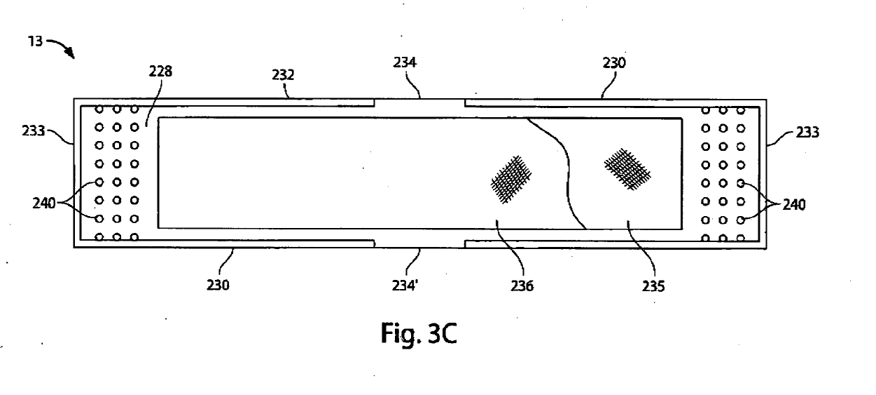

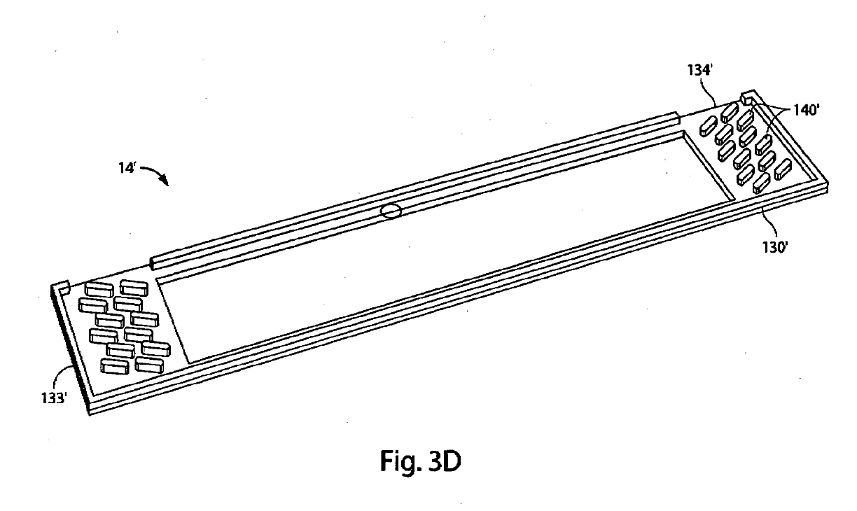

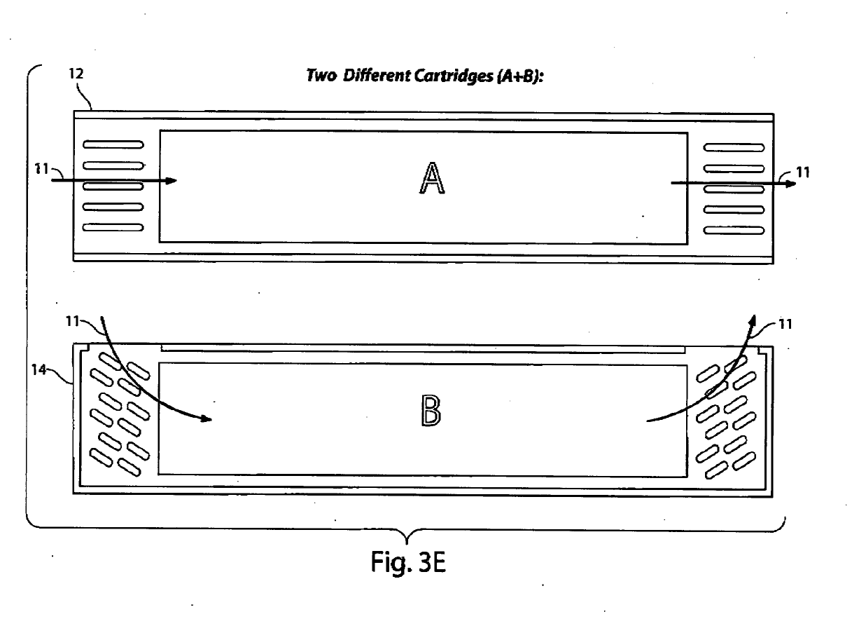

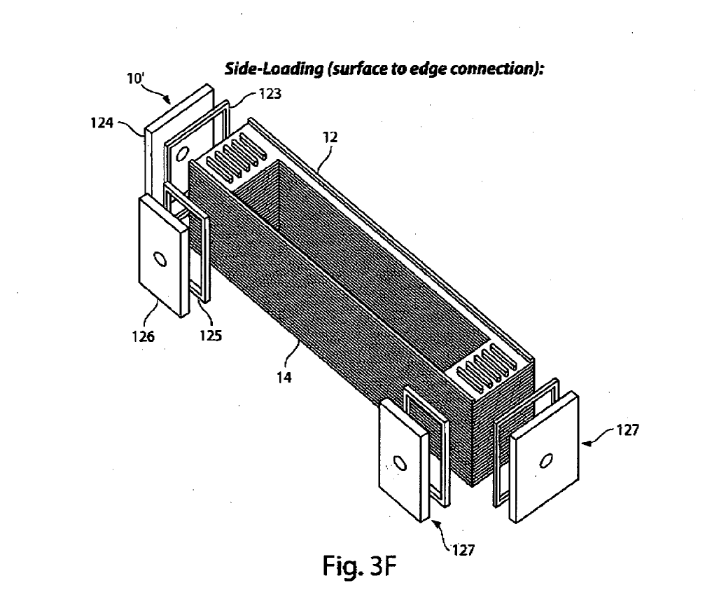

As shown in FIG. 2A, inlet 22a is in fluid communication with the openings 34 of the first membrane plates 12 (see FIG. 3A) to provide for the introduction of a stream to the associated membranes. The stream will flow across the membrane surfaces of the associated plates, but will be blocked from the other membrane plates (e.g., alternating membrane plates 14) by the end ribs 133 that form the closed ends thereof. The stream (or a portion thereof) can then exit the module via outlet 22b. In an alternative embodiment, the module 10 can include a plurality of inlets 22a′ disposed, for example, on the end surface of the bulkhead 17. The multiple inlets 22a′ can be used in conjunction with, for example, baffling or other structures 39 that associate each inlet 22a′ with a specific membrane plate or subset of membrane plates. This alternative arrangement allows the membrane module 10 to accept multiple inlet streams of a particular source, for example, where a solvent-enriched solution is introduced to the membrane module 10 via multiple streams at different pressures and/or temperatures, as discussed below.

As shown in FIG. 2B, the first process stream 48 enters the module 10 through inlet port 22a and fills the space defined by the bulkhead 17 and flows across the membranes plates 12 via openings 34, not shown but represented by arrows 41. End plate 24 sealingly engages the membrane plate arrangement within the module and helps prevent the first process stream from migrating around the membrane plate openings 34. End plate 26 similarly seals the membrane plates within the module 10 and prevents the second process stream 50 from migrating around membrane plate openings 134. The end plates 24, 26 can also provide support to the membrane plates. In the case of three or more types of membrane plates, additional end plates can be provided to direct the additional streams to their corresponding openings/ports. The second process stream 50 enters the module 10 via inlet port 23a and fills the space defined by end plates 24 and 26. The second stream 50 is directed along membrane plates 14 via openings 134.

The lower portion of FIG. 2B depicts the alternative arrangement, where multiple inlets 22a′, 23a′ and outlets 22b′, 23b′ (not shown) are used. As shown, multiple first streams 48′, 48″ are introduced to the module 10 via inlets 22a′. Each stream 48′, 48″ is directed to a subset of membrane plates via baffling or similar structures 39 that divide the space defined by the bulkhead accordingly. Only one alternative inlet 23a′ is shown in FIG. 2B; however, there would likely be the same number of inlets 23a′ for the second stream 50′ as for the first stream 48′. The specific number and arrangement of alternative ports 22′, 23′ will vary to suit a particular application. Alternative inlets 23a′ will introduce multiple streams 50′ into the space defined by end plates 24, 26, which will also be suitably divided by baffles or other structures. In some embodiments, no baffling or end plates are necessary, as the required structures can be built into the membrane plates themselves separately or formed when interconnected.

It should be noted that although the modules are primarily discussed with respect to membrane plates, these structures can also be applied to hollow fiber membrane bundles. For example, a module could include two or more bundles of hollow fiber membranes that perform different functions. In one embodiment, the various bundles can be staged or staggered within the housing where the ends of the bundles can be potted and/or include manifolds that correspond to the various spaces defined by the baffles/end plates that in turn correspond to the various inlets and outlets. These manifolds can also provide the flow paths as necessary to facilitate flow between bundles to suit a particular application. This arrangement allows different hollow fiber bundles (e.g., forward osmosis, heat exchange, and contact membranes) to be included in a single module, where the bundles are staged to carry out successive operations on the various process streams.

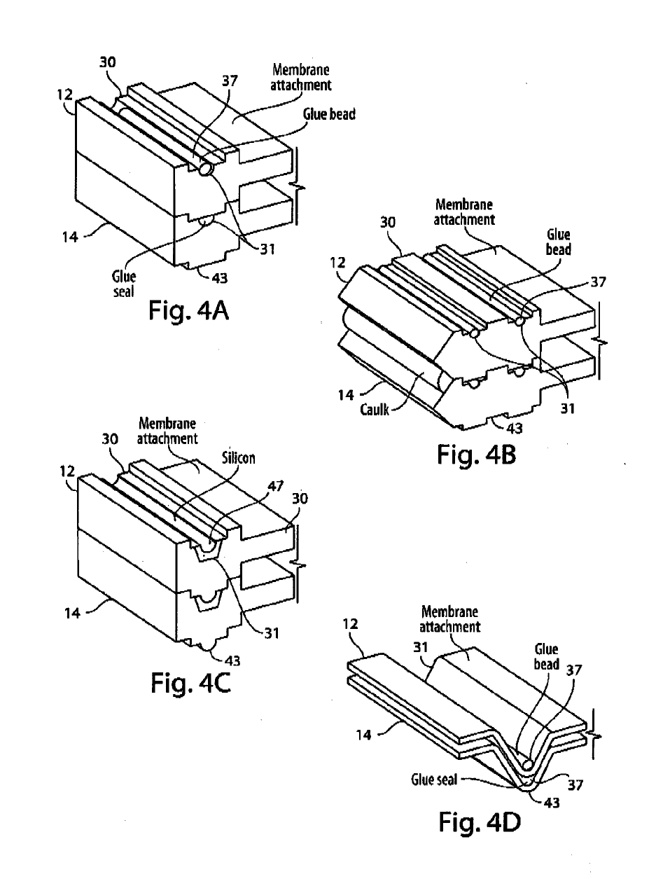

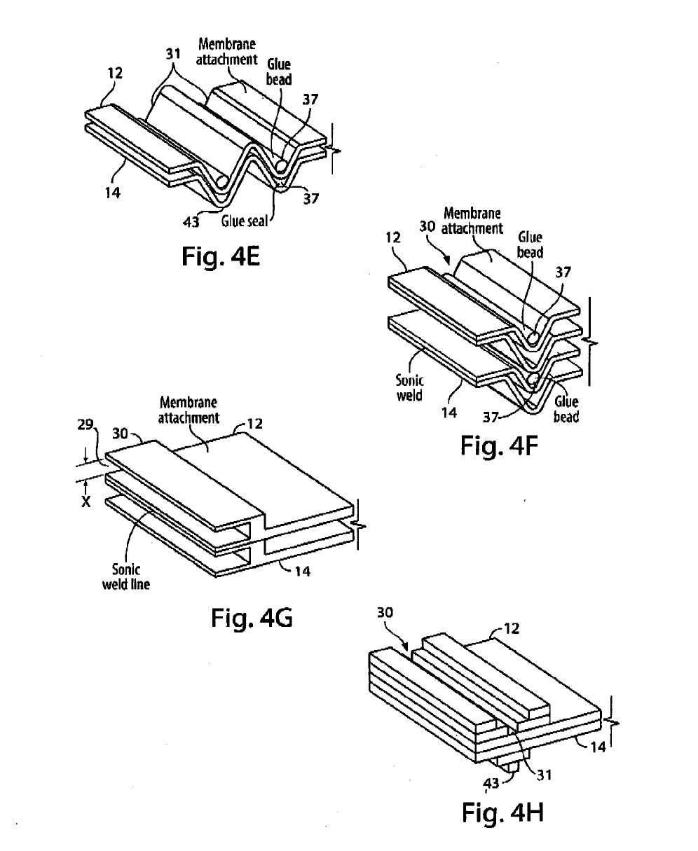

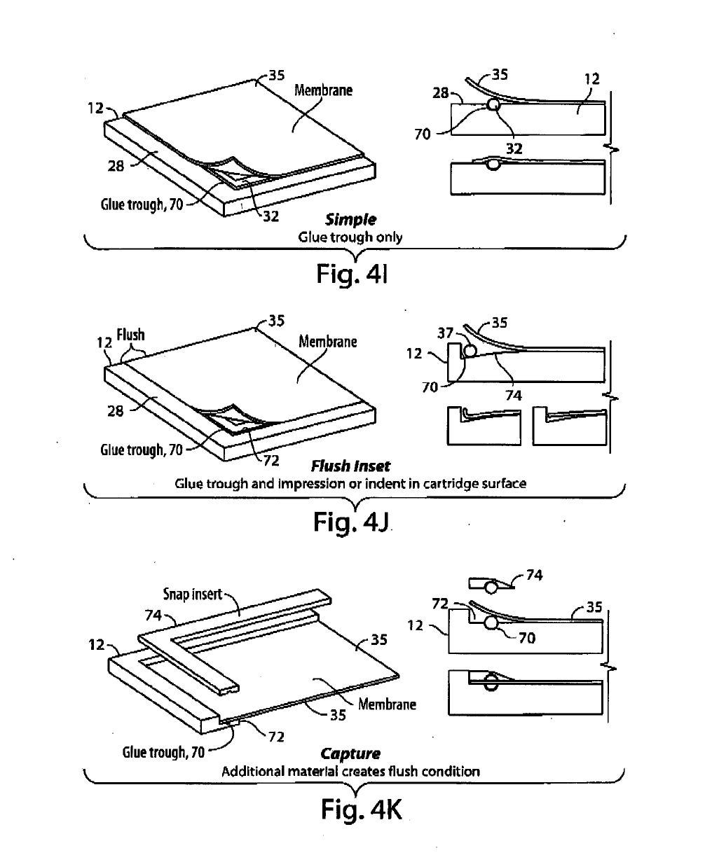

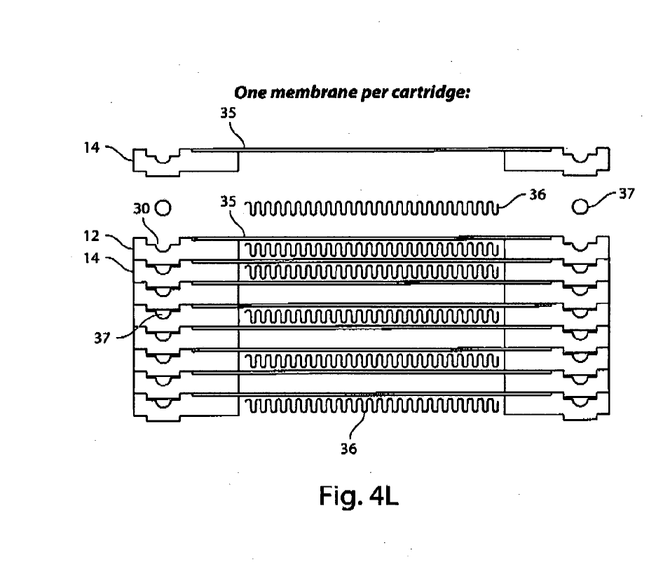

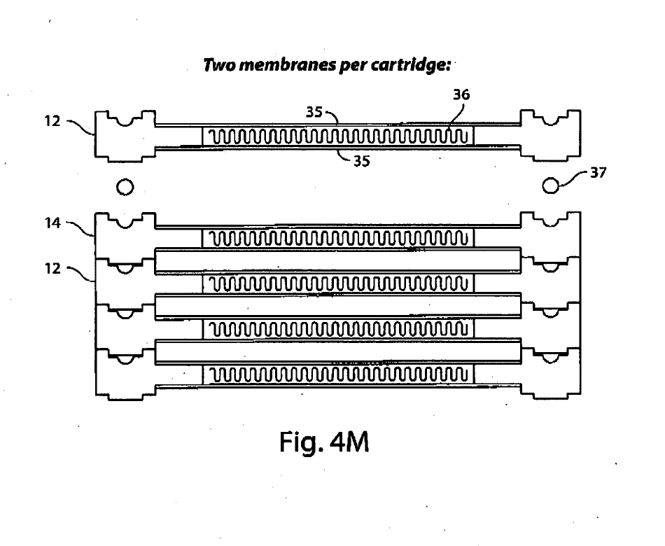

FIGS. 3A-3C depict three different membrane plate configurations. While only three configurations are specifically described, additional configurations can be derived from the three configurations described and are within the scope of the invention. With respect to FIG. 3A, a membrane plate 12 having an open end configuration is shown and described. The plate 12 has a generally planar, rectangular shape; however, other shapes are contemplated and within the scope of the invention. As shown, the plate 12 includes a generally planar surface or body 28 and two ribs 30 (i.e., interlocking mechanism) running the length of the plate's longitudinal sides. The ribs 30 define first and second openings 34 disposed at the ends of the plate 12. These openings 34 will correspond to ports in the housing 16, as previously described or may interface with other porting structures (e.g., manifolds, bulkheads). The ribs 30 are configured to allow for stacking and interlocking with complimentary membrane plates. In some embodiments, the ribs 30 have complimentary shapes to facilitate interlocking between plates. In other embodiments, the ribs 30 of one plate can be secured to the ribs of another plate via an adhesive, welding, or other mechanical means. For example, in one embodiment, a top surface of the rib 30 has a concave shape or otherwise defines a recess that is complimentary to a bottom surface of the rib 30, such that the bottom surface of the ribs of one membrane plate can snap fit into the top surface of the ribs 30 of another membrane plate. In one embodiment, the top surface of the rib 30 can have an adhesive disposed therein to provide a liquid-tight seal between membrane plates when assembled. See, for example, FIGS. 4A-4H.

The surface 28 defines an opening 32. In the embodiment shown, the ribs 30 direct the flow of any process steams along the length of the plate 12 from one open end 34 to the opposing open end 34′ and across the opening 32. As shown, the opening 32 is generally rectangular in shape and centrally disposed in the surface 28 and runs a substantial portion of the surface 28 in order to provide a maximum amount of membrane surface exposure. However, the overall size, shape, and location of the opening 32 can vary to suit a particular application. In addition, the surface 28 can define multiple openings 32. For example, in one embodiment, the surface 28 includes two openings evenly spaced in the surface 28, with rib and opening arrangements corresponding thereto. In one embodiment, the opening is covered or otherwise filled with a mesh sheet 36 and a semi-permeable membrane sheet 35. In alternative embodiments, the opening is covered with either a mesh sheet 36 or a membrane sheet 35 depending on the intended function of the plate in the module 10. The mesh sheet 36 can act as a spacer to maintain the spacing between membrane sheets 35 and assist the flow of a liquid or gas between membrane plates and membrane sheets. The mesh sheet 36 can also provide aeration to any liquid passing between the membrane plates.

In one embodiment, the membrane sheet 35 is a forward osmosis membrane that includes a feed side and a permeate side. As the membrane plates are constructed, the orientation of the membrane sheets 35 on each plate will be alternated, so that when the membrane module 10 is assembled, the feed sides and permeate sides of the membrane sheets 35 will be facing one another in an alternating fashion. In alternative embodiments, the mesh sheet can be disposed within the opening 32 or formed with the membrane plate, for example, a lattice structure formed within the opening during a molding process.

Alternatively, the opening 32 can be covered with an impermeable material to block the passage of any material therethrough (or a membrane plate without opening 32 can be used), thereby creating an inactive layer of the module. In one embodiment, the material can be an insulator to minimize the transfer of heat between membrane plates, for example, in an embodiment of a module used for a multi-stage process, as described hereinbelow.

The surface 28 can also include areas, for example end regions 38, that include one or more nubs or other geometric structure that act as spacers 40 for maintaining the spacing between the plates when they are assembled in the module 10. The spacers 40 can also provide structural support to the plates, for example, adding rigidity and/or supporting the weight of adjacent plates.

FIG. 3B depicts an alternative membrane plate 14, where the plate 14 has a closed end configuration. The basic construction of the plate 14 is substantially identical to that described with respect to FIG. 3A, insofar as the plate 14 includes a planar, rectangular surface 128, ribs 130 (i.e., interlocking mechanism), an opening 132, a membrane sheet 135, a mesh sheet 136, and spacers 140. The shape and configuration of the second plate 14 is complimentary to the first plate 12. However, the second plate 14 has ribs 133, 130 disposed along opposing ends and a substantial portion of each longitudinal side. The ribs 130 do not extend the entire length of the longitudinal sides, thereby creating lateral openings 134 formed between ribs 130 and ribs 133 and disposed adjacent end regions 138 of the plate 14. These lateral openings will also correspond to ports on the housing 16 (or other porting structures) to direct the flow of a process stream across the plate 14.

FIG. 3C depicts another alternative membrane plate 13, where the plate 13 has an open side configuration. The basic construction of the plate 13 is substantially identical to that described with respect to FIGS. 3A and 3B, insofar as the plate 13 includes a planar, rectangular surface 228, ribs 230, 233 (i.e., interlocking mechanism), an opening 232, a membrane sheet 235, a mesh sheet 236, and spacers 240. The shape and configuration of the third plate 13 is complimentary to the first and second plates 12, 14, or any other plates with which it is assembled. It should be noted that not every membrane module in accordance with the invention needs to include three different plate configurations and may include any number and configuration necessary to suit a particular application. This modularity provides great flexibility for creating membrane modules from standardized parts to suit almost any application. The third plate 13 has ribs 233, 230 (interlocking mechanisms) disposed along opposing ends and portions of each longitudinal side. The ribs 230 do not extend the entire length of the longitudinal sides, but instead cover a portion of the longitudinal sides corresponding to the end regions 238 of the plate 13, thereby creating approximately centrally located lateral openings 234. As discussed above, the openings 234 will correspond to ports in the housing 16. Additional plate configurations are possible and rely, in part, on the location and extent of the ribs along the periphery of any particular plate to form openings that can be coordinated with the location of ports in the housing 16 (or other porting structures).

FIG. 3D represents an alternative configuration of the membrane plate 14 depicted in FIG. 3B; however, some or all of the alternative features can be incorporated into any of the membrane plates described herein. As shown in FIG. 3D, the membrane plate 14′ is substantially similar to membrane plate 14, but with the openings 134′ limited to one common longitudinal side of the plate 14′. In addition, the plate 14′ includes spacers 140′ having an elongate configuration.

FIG. 3E depicts the interrelationship between two of the membrane plates 12, 14′, where plate 12 has an “A” configuration, plate 14′ has a “B” configuration, and the module is formed by alternating A and B configurations, e.g., A, B, A, B, etc. The relative streams are shown by arrows 11. A module 10 in accordance with one or more embodiments of the invention can include any number and type of membrane plates assembled in a like manner. Alternatively, the plates can be assembled in a variety of arrangements such as, for example, A, A, B, A, A, B, etc. or A, B, C, A, B, C, etc., which is another advantage of membrane modules manufactured in accordance with one or more embodiments of the invention.

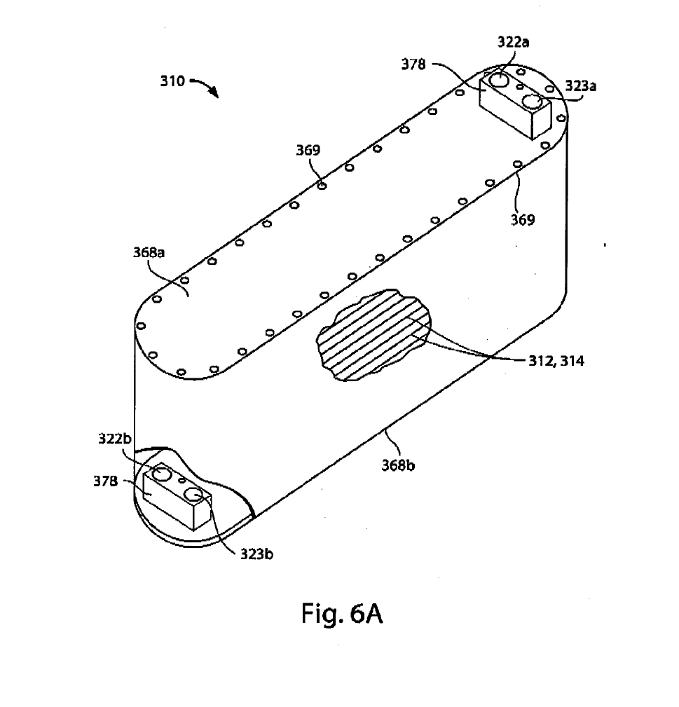

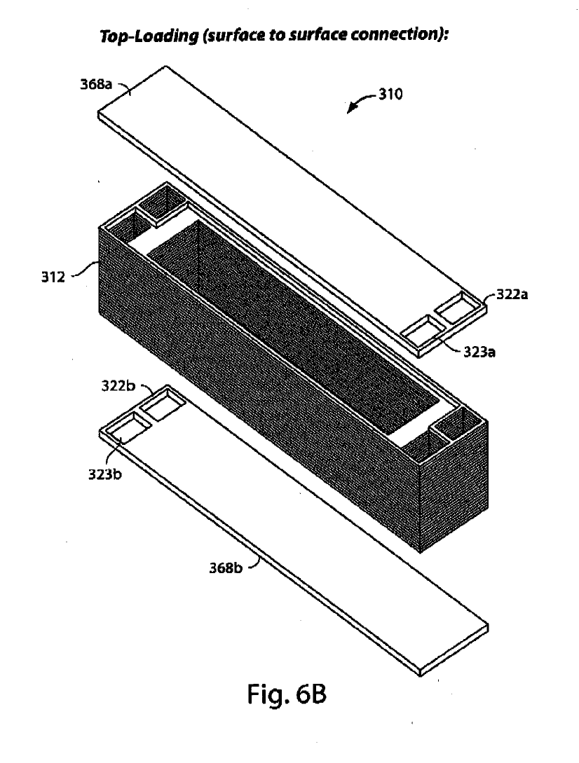

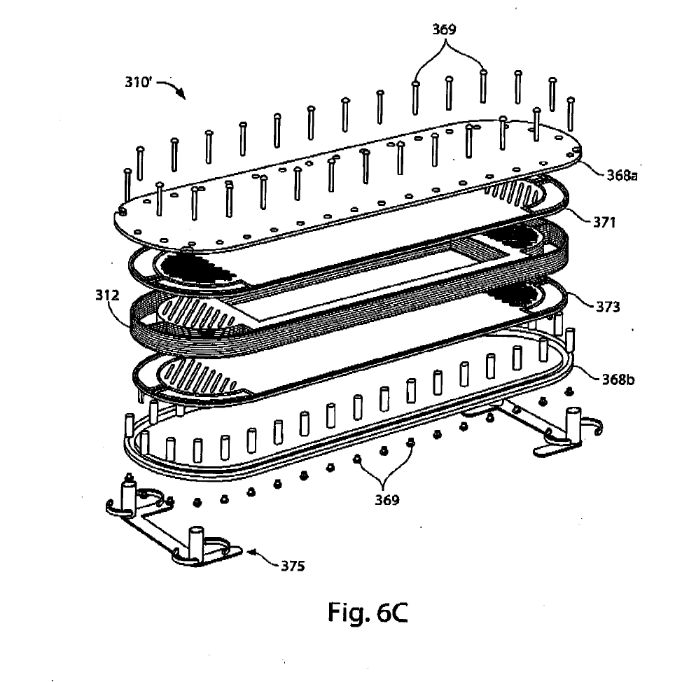

FIG. 3F depicts an alternative manner of assembling membrane module 10′, where a separate housing is not required. This arrangement is typically better suited to a low pressure application as it relies on the interconnection of the individual membrane plates 12, 14 and blank top and bottom plates (not shown) for sealing. Alternatively or additionally, the module assembly can be clamped together using the top and bottom plates as discussed in greater detail with respect to FIG. 6A. As shown in FIG. 3F, porting plates 124, 126 and sealing rings 123, 125 (i.e., manifold assemblies 127) are attached to the assembled membrane plates about the open areas of the plates 12, 14, which are made up of the aligned openings 34, 34′, 134, 134′. The plates 124, 126 and sealing rings 123, 125 can be secured to the module 10′ via an adhesive and/or other mechanical means. One possible benefit of this arrangement is that it provides access to the membrane plate openings 34, 34′, 134, 134′, such that individual openings can be blocked in the event of, for example, a membrane rupture. Additionally, this arrangement also makes other maintenance of the module 10′ possible.

Various components of the modules can be manufactured from a variety of materials including, for example, polymers, polymer blends, and block co-polymers and can be manufactured by, for example, molding, extrusion, stamping, or other known manufacturing techniques. The various membrane sheets can be manufactured from any suitable materials, such as those disclosed in U.S. Patent Publication Nos. 2007/0163951, 2011/0036774, 2011/0073540; and 2012/0073795; the disclosures of which are hereby incorporated by reference herein in their entireties. The mesh sheets can be manufactured from any suitable polymeric material. The particular materials used will be selected to suit a particular application and should be able to withstand the various process conditions, for example, high temperatures, and for fluid compatibility.

The overall size and number of membrane modules and membrane plates will be selected to suit a particular application with a focus on providing a specific total membrane surface area. In addition, the membrane parameters will also be selected to suit a particular application with a focus on obtaining a particular flux rate, where flux (J_{W})=A (Δπ−ΔP), where A=specific permeability (m/s/atm); Δπ=osmotic pressure difference at surface of membrane selective layer, and ΔP=pressure across membrane. The flux rate will also be impacted by the flow rates of the draw and feed solutions, which will be chosen to maximize residence time, but minimize concentration polarization (CP). In one example, a module having 50 membrane plates, each having an active membrane area of about 1′ by 3′ (3 ft²) will result in an approximate total effective membrane surface area of 150 ft². If used, for example, with a thin film composite polyamide membrane designed for osmotically driven flux, a flux of approximately 1500 gallons per day would be expected from a module of this type, used in a seawater desalination environment with an average flux of 10 gallons per ft² per day (GFD).

Alternatively, multiple smaller membrane modules can be used in series or multiple stacks assembled in a single housing to achieve the same operating parameters. For example, ten modules may be arranged such that the first five have areas of 300 ft² each and are arranged in series, followed by five modules with 150 ft² each, also in series. A module array of this type could be expected to produce approximately 22,500 gallons per day of permeate.

FIGS. 4A-4H depict a variety of edge connections for the assembly of the membrane plates. FIG. 4A is an enlarged cross-sectional perspective view of a portion of two membrane plates 12, 14 and depicts one possible mode of interconnecting the various membrane plates. As shown in FIG. 4A and previously discussed, the ribs 30 can include a recess 31 in an upper surface thereof that is sized and shaped to form a snap-fit with a bottom surface 43 of the ribs 30. The recess 31 can be sized such that an adhesive material 37 (e.g., a glue bead) can be added to the recess 31 to further secure the plates 12, 14 when assembled. In the embodiment depicted, the membrane plate is manufactured by injection molding.

FIG. 4B depicts an alternative to the arrangement shown in FIG. 4A, where the rib 30 is slightly larger to accommodate a double snap fit and two recesses 31 for receiving an adhesive 37. The ribs 30 can be sized and shaped to form multiple complimentary projections and recesses for providing the multiple snap fits and create an exterior trough 45 for receiving caulking or other sealing material. FIG. 4C depicts a similar arrangement where the ribs 30 form a snap fit, but without the use of an adhesive. Instead, the rib is formed with a silicon seal 47 during the injection molding process.

FIGS. 4D-4F depicts three alternative connection arrangements that may be used with membrane plates that are thermoformed. FIG. 4D depicts an arrangement where the rib 30 is essentially a V-shape formation along at least a portion of a periphery of the membrane plates 12, 14; however, other shapes are contemplated and considered within the scope of the invention. The membrane plates 12, 14 are held together via the complimentary, interlocking shapes and an adhesive 37. FIG. 4E is substantially similar to the arrangement of FIG. 4D, but with two interlocking complimentary ribs 30 and associated adhesive lines 37. FIG. 4E represents an alternative arrangement where each membrane plate is in the form of a cartridge formed by two separate plates connected via sonic welding. The cartridges are interconnected via adhesive 37 between complimentary shaped ribs 30 and/or additional sonic welding.

FIG. 4G depicts an additional embodiment where the membrane plates are manufactured via injection molding and interconnected via sonic welding. As shown, the ribs 30 are formed with a gap 29 along their edges defining a space “X” that is sized to accommodate the sonic horn. FIG. 4H depicts a variation of FIG. 4A, where the interconnection of the membrane plates 12, 14 is accomplished via a snap fit and the use of an adhesive 37; however, the membrane plates 12, 14, and in particular the ribs 30, are manufactured using laser cut acrylic assembled, for example, as shown.

FIGS. 4I-4K depict the attachment of the membrane sheets 35, 135 to the membrane plates 12, 14. As shown in FIG. 4I, the membrane plate (the plate is labeled 12, but the attachment method is applicable to any of the membrane plate configurations depicted herein) includes a trough 70 formed in the planar surface 28 of the membrane plate 12 and extending about the periphery of the opening 32 formed therein. In at least one embodiment, the trough is designed to receive an adhesive 37 for securing the membrane sheet 35 to the membrane plate 12. In this arrangement, the membrane sheet 35 rests on the planar surface 28. In various embodiments, the planar surface 28 and/or the trough 70 may have a texturized surface for improving the adhesive connection. One or more types and placements of adhesive may be used to suit a particular application.

FIG. 4J depicts an alternative arrangement where the planar surface 28 includes a recess 72 disposed about the periphery thereof and the trough 70 is formed within the area defined by the recess 72. The membrane sheet 35 is similar attached to the membrane plate 12 via one or more adhesives 37, but sits flush within the recess 72. In the case of an injection molded membrane plate 12, the depth of recess 72 will be dependent on the minimum plate thickness possible. As previously discussed, the size of the membrane plates and overall module will be selected to suit a particular application.

FIG. 4K depicts yet another alternative arrangement for attaching the membrane 35 to the membrane plate 12. As shown, the membrane plate 12 includes the aforementioned recess 72 and trough 70 and also includes an insert 74 that can be attached to the membrane plate 12 via a snap fit and/or an adhesive. The insert 74 further secures the membrane sheet 35 to the membrane plate 12. In an alternative embodiment, the insert 74 can be sonic welded to the plate 12. In a particular embodiment, the insert 74 will sit flush with the planar surface 28 of the membrane plate 12. In another embodiment, the insert 74 is flush with the ribs 30. Typically, the membrane sheet will be slightly recessed relative to at least a portion of the membrane plate, e.g., the ribs 30 and/or planar surface 28.

FIGS. 4L and 4M depict the assembly of at least a subset of membrane plates 12, 14. As shown in FIG. 4L, each membrane plate 12, 14 includes a single membrane 35 attached to the top planar surface 28 thereof. The plates 12, 14 are stacked one upon another and secured, for example, via a snap fit between ribs 30 and an adhesive 37. The optional mesh sheets 36, which can provide support to maintain the spacing between membrane sheets 35 and provide turbulence to the streams flowing between the plates 12, 14, are disposed within the openings 32 formed within the plates 12, 14. The mesh sheets 36 can be secured to the plates via an adhesive or other known mechanical means, or be formed therewith. Additional mesh sheets 36 can be disposed between membrane sheets 35 as necessary to suit a particular application. Alternatively, the membranes 35 can be attached to the top or bottom surface of a particular membrane plate to suit a particular application, for example, controlling the space between membrane sheets 35. For example, in one embodiment, the membrane sheets 35 are arranged such that the feed sides of two adjacent membrane plates are disposed closer to one another with a mesh sheet disposed therebetween, while the permeate sides are spaced farther apart.

FIG. 4M depicts an arrangement where each membrane plate includes two membrane sheets 35 attached thereto forming a membrane cartridge. As shown, a membrane sheet 35 is attached to each of a top surface and a bottom surface of the membrane plate via any of the aforementioned methods, and a mesh sheet 36 is disposed between the membrane sheets 35 and can be secured to the membrane plate 12, 14. This arrangement provides for a thicker membrane plate, which may make the plates easier to manufacture and result in fewer adhesive joints when assembled. However, the openings in the membrane plates will be more complex to accommodate a flow path between membrane sheets 35. Alternatively, the membrane plates may be surrounded by a frame that is configured to allow for the bolting together of the membrane plate stack such that the plates are functionally clamped together. The frame arrangement can be used in place of or in conjunction with the use of adhesives.

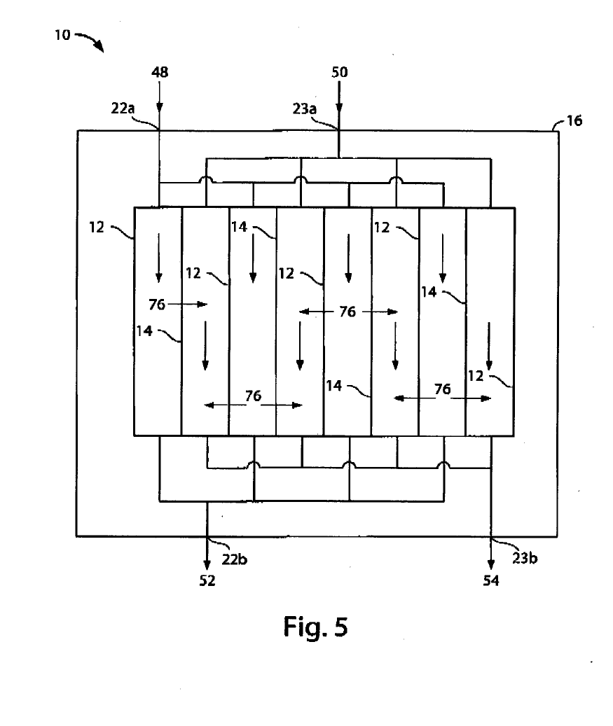

FIG. 5 depicts schematically the operation of the basic membrane module 10 that utilizes two different membrane plates 12, 14 to create a particular flow pattern, but a single type of membrane, in this case a forward osmosis membrane. In this embodiment, the membranes are oriented on the alternating membrane plates in a manner such that the permeate and the feed sides of adjacent membranes are facing one another. As shown in FIG. 5, a first process stream 48, in this case a feed solution is introduced to the membrane module 10 via inlet 22a. The first stream 48 enters the spaces created between alternating membrane plates via openings 34 disposed at the ends of the membrane plates 12 (see, for example, FIGS. 2A. 2B, and 3A). A second stream 50, in this case a draw solution, is introduced to the membrane module 10 via inlet 23a. The second stream 50 enters the spaces created between alternating membrane plates via openings 134 disposed near the ends of the membrane plates 14 (see, for example, FIGS. 2A, 2B, and 3B). A solvent passes through the membranes from the feed solution to the draw solution (arrow 76).

The solvent depleted feed solution exits the membrane module 10 via outlet 22b as a third stream 52. The third stream 52 can be directed to additional membrane modules or elsewhere for further processing and/or recycling/disposal. The solvent enriched draw solution exits the membrane module 10 via outlet 23b as a fourth stream 54. The fourth stream 54 can also be directed to additional membrane modules or elsewhere for further processing. In some embodiments, the fourth stream 54 is directed to a recycling process to recover draw solutes and produce, for example, potable water.

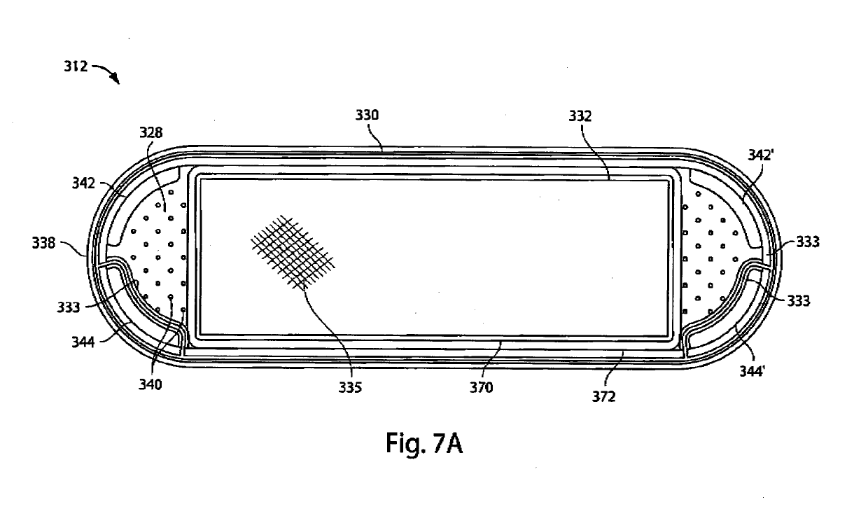

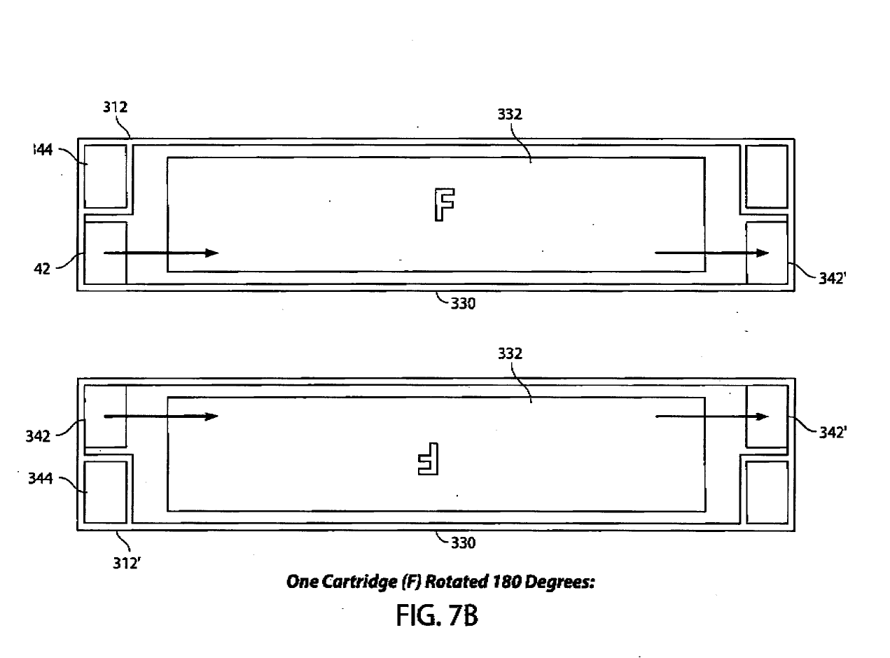

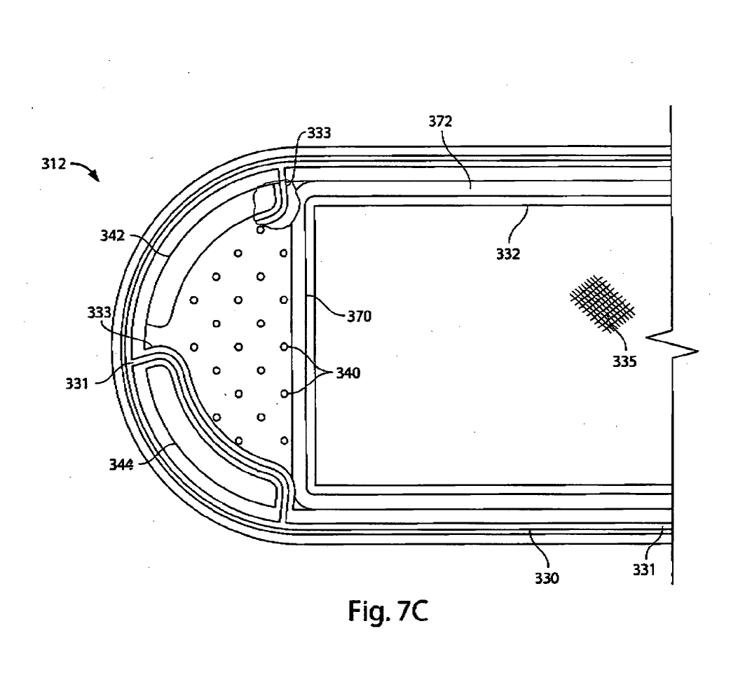

FIG. 6A depicts an alternative membrane module 310. As shown, the membrane module 310 includes a plurality of alternating membrane plates 312, 314. In one embodiment, the plates 312, 314 are disposed within a pressure vessel or a housing similar to that described with respect to FIG. 1. Alternatively, the membrane module 310 can be assembled as described with respect to FIGS. 4A-4H and not require the use of a separate housing. For example, the module 310 can be assembled with top and bottom plates 368a, 368b that include a manifold or port block 378 that interfaces with the internal porting of the membrane plates (see FIGS. 7A-7C) and provides the inlet and outlet ports 322, 323 for interfacing with the various sources of process streams. In some embodiments, the top and bottom plates 368 can include means for bolting the membrane plate stack together to form the finished module 310. In one embodiment, the plates 312, 314, 368 include clearance holes that can accommodate bolts or threaded rods 369, where the clearance holes are disposed outside of the flow paths to prevent leakage. In another embodiment, the top and bottom plates 368 have slightly larger outside dimensions than the membrane plates 312, 314 such that bolts or threaded rods 369 can extend between plates 368a, 368b outside of the stacked membrane plates 312, 314. In some embodiments, the top and bottom plates 366a, 368b are identical and are rotated 180° degrees apart. This arrangement tends to be easier to assemble, because the use of the clamping force eliminates the need for smooth edges/ribs and creates better seams for caulking, if necessary. In addition, the use of a “clamped” assembly method may allow the module 310 to operate at higher pressures than a module without a housing assembled according to the other methods described herein.

FIG. 6B depicts an alternative version of the module 310 of FIG. 6A. As shown, the module 310 includes a plurality of stacked membrane plates 312, a top plate 368a, and a bottom plate 368b. The ports 322, 323 are formed directly in the top and bottom plates 368. The plates 312, 368 are secured via any of the aforementioned methods. Alternatively or additionally, the ports 322, 323 in the top and bottom plates 368 can be threaded, flanged or other configuration to accommodate various piping systems and connections.

FIG. 6C depicts yet another alternative embodiment of a membrane module 310′. Similar to the module 310 of FIG. 6B, the module includes a plurality of stacked membrane plates 312 and top and bottom plates 368a, 368b that are used to sandwich the assembly together. In this particular embodiment, the module 310′ also includes a blank top membrane plate 371 that includes openings that correspond to the module ports, but no opening where the membrane would normally be located, and a blank bottom membrane plate 373 that does not include any openings or membranes. In some embodiments that include the blank top and bottom membrane plates 371, 373, the top and bottom plates 368 that are used to secure the assembly can be replaced by lighter-weight rings. The module 310′ is held together with a series of fasteners 369 that may include spacers to suit. The module 310′ can also include brackets 375 to assist in supporting, mounting, and/or handling the assembled module.

FIG. 7A depicts one embodiment of a membrane plate 312 for use in the alternative membrane module 310 of FIG. 6A or 6B. As shown, the membrane plate 312 has a generally rectangular shape, but with slightly rounded end regions 338. In some embodiments, the end regions 338 correspond in shape to the ends of a pressure vessel or housing. However, the shape of the plate 312 can vary to suit a particular application. As discussed with respect to FIG. 7B, a single membrane plate configuration can be used and assembled in an alternating pattern. Alternatively, the membrane plates can come in A and B configurations that are, in one embodiment, asymmetrical to prevent confusion during assembly, as they can only be assembled in one manner.

Similar to FIGS. 3A-3C, the membrane plate 312 includes a planar surface 328 that defines an opening 332 and four ports 342, 344. The ports 342, 344 are disposed in the end regions 338 of the surface 328 and the opening 332 extends along substantially the entire length of the surface 328 and between two opposing ports 342, 342′. The ports/openings 342, 344, 332 can be round, square, oblong, etc. to suit a particular application and/or method of manufacture. The plate 312 includes a rib 330 that extends along the entire periphery of the plate 312 and provides a means for interconnecting the plates 312, for example, as described with respect to membrane plates 12, 14 in FIGS. 4A-4H. The plate 312 includes additional ribs 333 that surround the alternative ports 344, 344′. Ports 342, 342′ and opening 332 are bounded by the ribs 330, 333, which define a flow path between ports 342, 342′ and across opening 332. Ports 344, 344′ are isolated from the stream flowing between ports 342, 342′, and provide a pathway to an adjacent membrane plate. The bottom surface of the membrane plate 312 has a substantially symmetrical rib pattern to the top surface rib pattern to promote the flow of a second process stream between ports 344, 344′ and the opposite side of the membrane itself.

As shown in FIG. 7B, two identical plates 312 are oriented and assembled rotated 180° degrees to each other. This arrangement produces a less expensive module, as only one plate configuration is required. The plates 312 are flipped or rotated during assembly. However, in alternative embodiments, plates 312 having different configurations are provided, for example, to reduce possible assembly errors and/or accommodate additional process streams. When assembled, the stream passing through port 344 enters port 342 in the adjacent plate 312 and is directed across the opposite side of the membrane sheet 335 and, depending on where in the stack the particular plate is located, across a second adjacent membrane sheet 335. Alternative ports 344, 344′ allow two process streams to pass through the membrane module 310 across the adjacent membrane plates 312.

FIG. 7C is an enlarged view of a portion of the membrane plate 312 and depicts one possible mode of attaching membrane sheets thereto and interconnecting the various membrane plates. As shown in FIG. 7C, and previously discussed, the ribs 330, 333 can include a recess 331 in an upper surface thereof that is sized and shaped to form a snap-fit with a bottom surface of the ribs 330. The recess 331 can be sized such that an adhesive material 337 can be added to the recess 331 to further secure the plates 312 when assembled. See, for example, FIG. 4A. The rib 333 extending about port 344 on the top surface of the plate 312 blocks the flow of a process stream from that port across the top surface of the membrane plate 312. An identical rib arrangement is disposed about port 342, but on the bottom surface of the membrane plate 312, to block the flow of a process stream from that port across the bottom surface of the membrane plate 312 (and the top surface of an adjacent membrane plate 312). This arrangement of ports and ribs 333 direct two or more process streams across the proper sides of the membrane sheet 335.

In one embodiment, the opening 332 is slightly smaller in size than the area bounded by the rib 330, thereby creating a lip upon which the membrane sheet 335 can be disposed. The membrane sheet 335 can be secured to the surface 328 via any of the methods discussed above. The placement of the membrane sheet 335 and ribs 330 directs the flow of a process stream (e.g., a gas or liquid) laterally from one port (e.g., inlet 342), across the membrane surface, and out the other port (e.g., outlet 342′). As shown in FIG. 7C, and as described with respect to FIGS. 3A-3C and 4I-K, the membrane sheet 335 is attached to the membrane plate 312, for example, via a recess 372 and a trough 370. The membrane plate 312 may also include a mesh sheet attached thereto.

The membrane modules have generally been described where the membrane plates are stacked in a planar fashion during assembly; however, the finished module may be oriented such that the membrane plates are aligned vertically on their longitudinal sides to, for example, better distribute the weight of the assembly. Additionally, the various membrane plates with mesh and membrane sheets attached thereto can be produced as sub-assemblies and finally assembled and stacked vertically to prevent the bottom layers from being crushed by the weight of the numerous membrane plates.

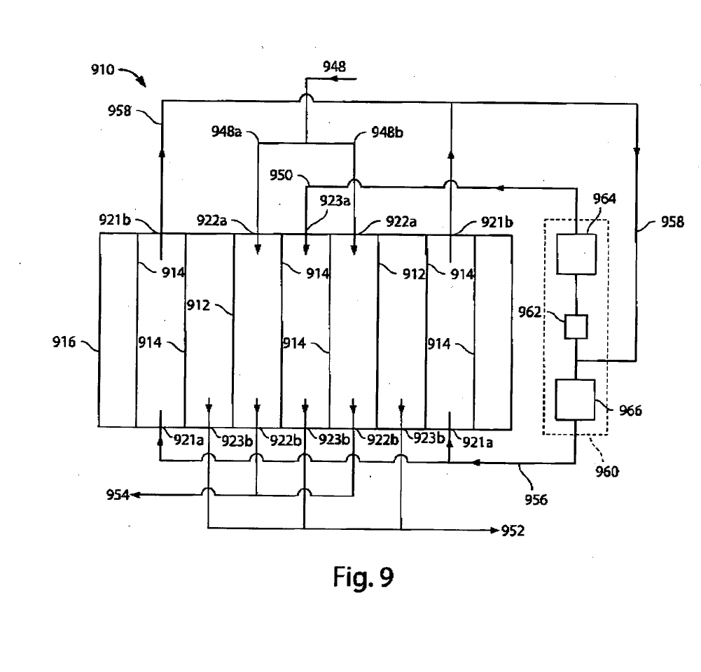

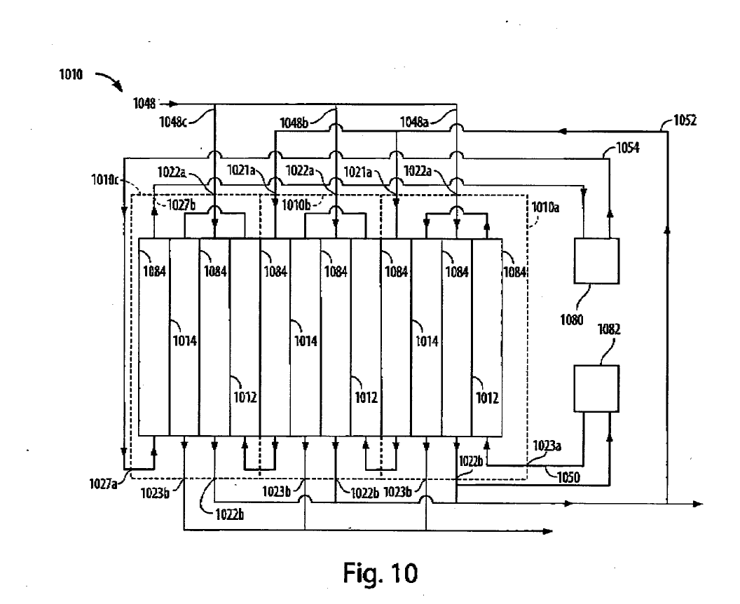

The preceding types of construction can also be used for a variety of contact membranes as well, such as those disclosed in U.S. Patent Publication No. 2012/0067819, the entire disclosure of which is hereby incorporated herein by reference. For example, the '819 publication discloses in FIGS. 9 and 10 the use of multiple contact membranes, which could be assembled as a membrane module in accordance with an embodiment of the present invention.

Alternatively or additionally, more than one type of membrane plate can be used in a single module, for example, heat exchange and contact membranes. The use of multiple membrane plates with different configurations (i.e., flow paths) allows for the customization of a membrane module depending on the desired operating characteristics or functions thereof. For example, the size and number of membrane plates can be chosen to suit a particular flow rate and/or installation site. Additionally, the number, types, and arrangement of membrane plates can be selected to suit a particular function, for example, multi-stage distillation. The number and arrangement of ports on the module can also be selected to suit a particular application or function, for example, the introduction of a single process stream as multiple streams having different operating characteristics.

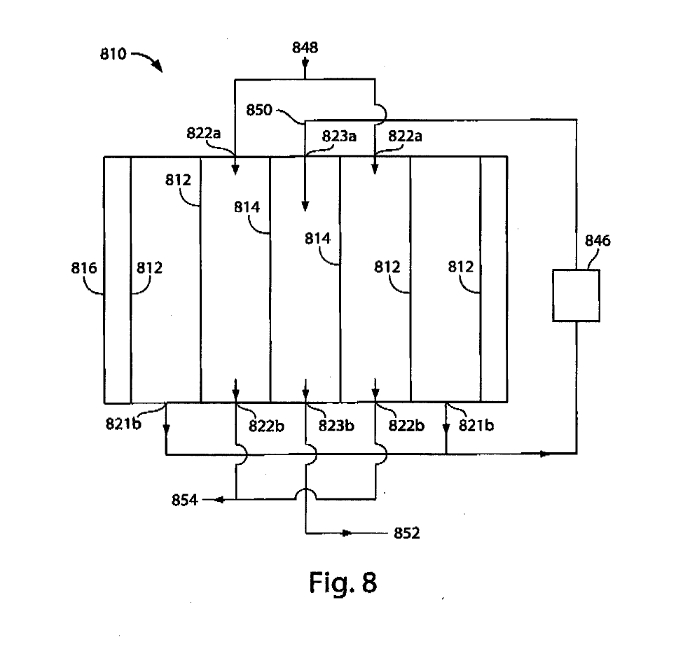

FIGS. 8-10 are schematic representations of possible membrane modules that can be constructed in accordance with various embodiments of the invention. Alternatively, these various membrane arrangements can also be produced in accordance with conventional membrane module formats, such as, for example, plate and frame, spiral wound, and hollow fiber. FIGS. 8-11 also depict the use of multiple types of membranes in order to achieve a multi-stage or multi-effect device. In the case of an arrangement in accordance with the invention or a plate and frame type arrangement, the different membrane layers will carry different streams. In the case of a hollow fiber type module, both types of fibers are mixed with potted ends to separate the streams.

These various membrane modules can be used in conjunction with forward osmosis membrane modules to assist in the recovery of a desired solvent and/or to recycle solutes, for example, as condensers, reboilers, crystallizers, multi-effect distillation devices, and multi-effect solute stripping devices. In addition, these membrane modules can be used in conjunction with other types of desalination units, such as, for example, the forward osmosis systems disclosed in U.S. Pat. Nos. 6,391,205 and 7,560,029 and PCT Application Nos. PCT/US09/048,137, filed Jun. 22, 2009; PCT/US10/054,738, filed Oct. 29, 2010; and PCT/US10/054,512, filed Oct. 28, 2010, the disclosures of which are hereby incorporated herein by reference in their entireties.

FIG. 8 depicts a portion of one possible membrane module 810 using two different types of membranes. For clarity, FIG. 8 depicts the module 810 as having four contact membranes 812 (for the exchange of vapor) and two heat exchange membranes 814 disposed in a housing 816; however, in this configuration, there would be additional heat exchange membranes 814 disposed on the other sides of the outermost contact membranes 812 and additional alternating contact and heat exchange membranes 812, 814 could also be included and the plates could be assembled without the use of a separate housing. Alternatively, the module 810 could be limited to two contact membranes 812 and two heat exchange membranes 814; however, any number and combination of membranes may be selected to suit a particular application. The system depicted in FIG. 8 also includes a compressor 846.

In one embodiment, the membrane module 810 is used as a crystallizer. In general, a heated fluid or steam is introduced into the module 810 to provide heat to a liquid stream containing seeded precipitate particles via one of the heat exchange membranes 814. Water vapor will be produced that will evaporate through one of the contactor membranes 812, such that precipitation will occur on the seeded particles within the liquid stream.

As shown in detail in FIG. 8, a first stream or solution 848 (e.g., a salt solution or seeded slurry) is introduced into the module 810 via one or more inlets 822a disposed in the housing 816 (or module 810). A second stream 850 (e.g., steam) is introduced into the module 810 via one or more additional inlets 823a disposed in the housing 816 (or module 810). As shown in FIG. 8, stream 850 is introduced between the two heat exchange membranes 814, while the first stream 848 is introduced to the opposing sides of the heat exchange membranes 814 and the feed sides of the contactor membranes 812. The first stream 848 is heated causing water vapor to pass through the contact membranes 812. The water vapor or steam can exit the module 810 through one or more outlets 821b disposed in the housing 816 (or module 810) and can be recycled to the compressor 846. The second stream 850 can be reduced to water and removed from the module 810, via outlet(s) 823b as a third stream 852. In one embodiment, the first stream 848 is reduced to its constituent solutes that are removed from the module 810 as a fourth stream 854 via one or more additional outlets 822b disposed in the housing 816 (or module 810). In an alternative embodiment, solutes are vaporized out of the first stream 848 and through the contact membrane 812, and a solvent (e.g., water) is recovered via outlets 822b.

The module 810 depicted in FIG. 8 could be used as a variety of devices depending on the nature of the various streams introduced into the module 810. In one embodiment, the module 810 is used as a condenser, where cooling water is introduced to remove heat from a condensing stream via one of the heat exchange membranes 814, such that an absorbing stream or distillate is cooled, allowing a gas stream to absorb into it through one of the porous contactor membranes 812, which do not allow liquid flow. In one embodiment, the absorbing stream is a dilute draw solution and the gas stream is the tops vapor from the stripping of draw solutes. In addition, the membrane module 810 could also be used as a reboiler, where heated water or steam introduces heat to a liquid stream via one of the heat exchange membranes 814, which evaporates vapors through one of the contactor membranes 812.

FIG. 9 depicts a membrane module 910 similar to the module 810 of FIG. 8, but with the addition of a heat pump module 960. In one embodiment, the module 910 can be used as a crystallizer to further concentrate brine providing for zero liquid discharge. As similarly described with respect to FIG. 8, a first stream 948 is introduced into the membrane module 910 via inlets 922a between a pair of contact and heat exchange membranes 912, 914, and a second stream 950 is introduced via inlet(s) 923a into the module 910 between two heat exchange membranes 914. In one example, the first stream 948 is a salt solution or seeded slurry and the second stream 950 is steam. Heat from the steam is transferred through the heat exchange membrane 914 to the first stream 948 causing water to vaporize and pass through the contact membranes 912.

As shown in FIG. 9, the heat pump module 960 includes a heat pump 962, a boiler 964, and a chiller 966. The heat pump 962 and boiler 964 provide the second stream 950 of steam. The chiller 966 provides a fifth stream 956 in the form of cooling water that is introduced to the module 910 via inlets 921a. The cooling water absorbs the heat, via additional heat exchange membranes 914, from the vapor passed through the contact membranes 912 to create a distillate. The distillate exits the membrane module 910 as a third stream 952 via outlets 923b. The now heated cooling water exits the module 910 via outlets 921b as a sixth stream 958. In some embodiments, this third stream 952 is a desired solvent, such water. The remaining solutes from the first stream 948 exit the membrane module 910 as a fourth stream 954 via outlets 922b. In some embodiments, these solutes can be recycled to control the concentration of a draw solution used in a forward osmosis system. In other embodiments, the fourth stream 954 can be concentrated brine that can be, for example, recycled, disposed of, or further processed through another membrane module to remove additional water.

In some embodiments, the module 910 of FIG. 9 can also be used as a multi-effect distillation device by using alternating heat exchange and contact membranes 914, 912. The first stream 948 in the form of, for example, a seeded slurry is introduced into multiple channels, each at a different temperature and pressure (e.g., streams 948a, 948b, etc.), such that as steam condenses in one channel, seeded slurry on either side of the heat exchange membranes 914 evaporates steam through the contact membranes 912, which then condenses on the next set of heat exchange membranes 914, on the other side of which is a similar seeded slurry stream, but at a lower pressure and temperature, and so on, thereby providing multiple “effects” or “stages”. In such an arrangement, the membrane module 910 can include the necessary porting to introduce and remove multiple streams to and from the module 910. As described above, the membrane modules can accommodate single streams passing continuously through the module 910 or multiple streams passing though the module 910 in parallel.

The membrane module 910 can be also used as a multi-effect solute stripping system, similar to a multi-stage column distillation system, but in a membrane configuration. The module includes a plurality of alternating heat exchange and contact membranes and the appropriate porting. Each draw solution to be stripped (streams 948a, 948b, 948c, etc.) is introduced to the membrane module 910 via an inlet to a particular channel at a different temperature and pressure. As steam condenses in one channel, draw solute stripping on either side of the heat exchange membranes evaporates solutes through the adjacent contact membranes, which then condenses by itself or into an absorbing solution on additional heat exchange membranes, on the other side of which is a similar stripping stream, but at a lower pressure and temperature, and so on, to get the multiple “effects” or “stages”.

FIG. 10 depicts an additional membrane module 1010 arranged for use as a multi-stage distillation system in accordance with one or more embodiments of the invention. Generally, the module 1010 includes a plurality of alternating heat exchange membranes 1014 and contact membranes 1012. The module 1010 also includes a series of insulating barriers 1084 (or other additional plates as discussed herein) between particular membranes. The module 1010 may also include insulated barriers as part of the outer most membrane plates to improve efficiency of the system. As shown in FIG. 10, the module 1010 can be used with an external boiler 1082 for supplying steam (stream 1050) to the module 1010 and an external cooler 1080 for supplying a cooling liquid (stream 1054) to the module 1010. An alternative module can include an integrated reboiler.

In one example, multiple dilute draw solution streams (streams 1048a, 1048b, etc.) are each introduced to the membrane module 1010 via an inlet 1022a to a particular channel at a different temperature and pressure. The dilute draw solution streams are introduced into the module 1010 in parallel. Steam (stream 1050) is introduced to the module 1050 via inlet 1023a and provides a source of thermal energy that passes through the various stages of the module 1050 serially. A third solution stream 1052 (e.g., water) is introduced to the module 1010 via one or more inlets 1021a. The fourth stream 1054 (e.g., a source of cooling water from cooler 1080) is introduced to the module 1010 via one or more inlets 1027a (depending on the number of stages and overall configuration of the module).

As shown in FIG. 10, the module 1010 is divided into multiple stages 1010a, 1010b, 1010c, etc. In one stage, the steam (stream 1050) is introduced on one side of a contact membrane 1012, on the other side of which is the dilute draw solution stream 1048. The dilute draw solution is heated causing the solutes therein to vaporize and pass through the contact membrane 1012 and into the steam. The remaining draw solution, less the solutes, exits the module 1010 via an outlet 1022b as potable water, where all or portions thereof can be used for various purposes or further processed. As shown in FIG. 10, a portion of the water is sent to the boiler 1082 for use as the source of steam, a portion is directed back to the module 1010 as the third process stream 1052, and a portion is used, for example, as potable water.

The steam, now containing the vaporized solutes, passes to another channel of the module 1010, which is bounded by an insulated barrier and a heat exchange membrane 1014. On the other side of the heat exchange membrane 1014 is the potable water (stream 1052), which is heated by the steam causing the steam to condense within its channel and at least a portion of the water (stream 1052) to turn into steam, which is then directed to the next stage (e.g., stage 1010b) of the module 1010 to provide heat to the next channel receiving a dilute draw solution stream (e.g., stream 1048b). The condensed draw solutes exit the module through one or more outlets 1023b, where they can be recycled for use in a draw solution or further processed. The afore-mentioned insulated barrier could include a coating or be formed of a material that may also act as a catalyst to assist in the recovery of draw solutes, for example, a catalyst that accelerates the absorption of certain solutes (e.g., CO₂) into solution. Alternatively or additionally, the catalyst or other material could be incorporated into the heat exchange membranes or additional plates.

The process continues as streams of dilute draw solution are introduced in parallel to successive stages of the module 1010, while the source of thermal energy is passed serially through the various stages of the module 1010. The number of stages and the operating conditions of the various streams can be controlled to suit a particular application. Examples of operating parameters can be found in U.S. Patent Publication No. 2009/0297431, the disclosure of which is hereby incorporated by reference herein in its entirety. For example, five stages may be created where the diluted draw solution flows in parallel to each stage, but the thermal energy flows in series from one stage to another, being effectively reused each time. At the last stage, or in some embodiments after a predetermined number of stages, the cooling water (stream 1054) is introduced to the module 1010 on the other side of a heat exchange membrane 1014 adjacent a channel containing the steam and vaporized draw solutes, condensing at least the vaporized draw solutes. The condensed draw solutes exit the module 1010 via one or more outlets 1023b, where they can be recycled or further processed depending on the system. The used cooling water exits the module 1010 via outlet 1027b and is returned to the external cooler 1080.

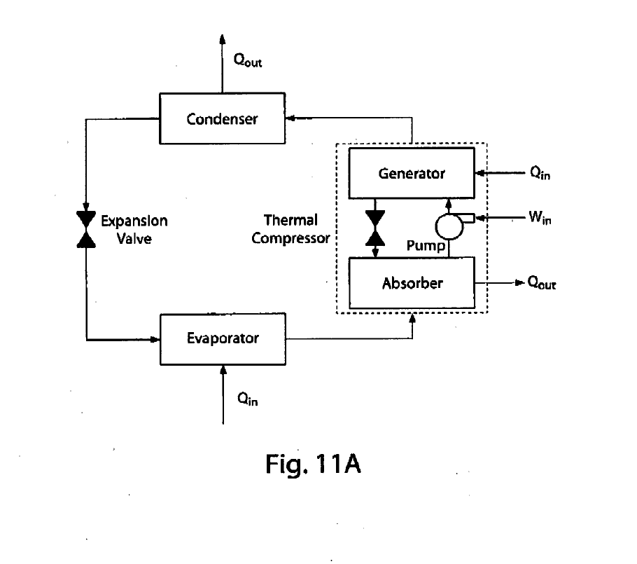

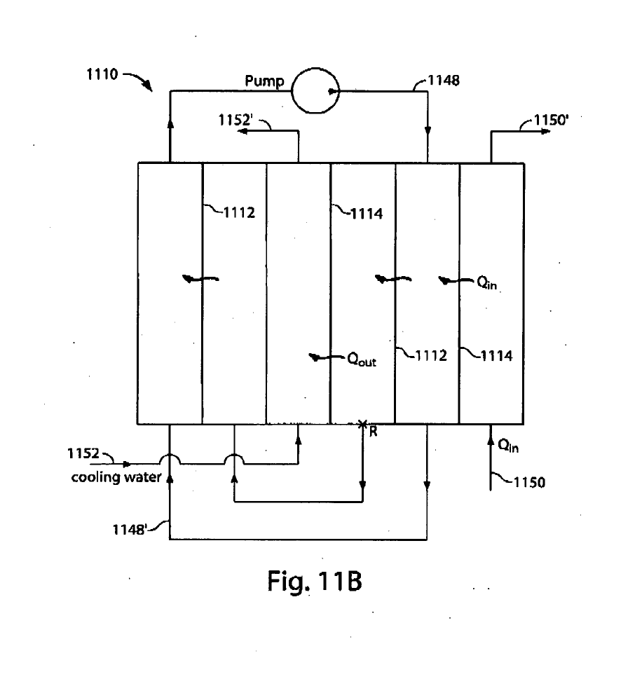

FIG. 11A is schematic representation of a vapor absorption cycle that can be performed, for example, using all membranes, as can be configured in accordance with any of the embodiments described herein, as shown in FIG. 11B. The chemical process is similar to that of a conventional absorption cycle, but the components are constructed of lower cost membrane based materials, which significantly decreases the overall cost. These components include; a membrane evaporator, membrane condenser, membrane absorber and membrane heat exchanger, which, in one embodiment, can be contained within a membrane module as described herein. Because the system can be entirely constructed of polymeric materials, the cost can be as much as 90% less than traditional metal-alloy construction. In addition, incorporating the various functions into a single module further simplifies the system, reduces its overall footprint, and makes it more readily deployable.

The absorption cycle was invented in 1846 by Ferdinand Carré for the purpose of producing ice with heat input and is based on the principle that absorbing ammonia in water causes the vapor pressure to decrease. Absorption cycles produce cooling and/or heating with thermal input and minimal electric input by using heat and mass exchangers, pumps and valves. An absorption cycle can be viewed as a mechanical vapor-compression cycle, with the compressor replaced by a generator, absorber and liquid pump. The absorption cycle enjoys the benefits of requiring a fraction of the electrical input, plus uses the natural substances ammonia and water, instead of ozone depleting halocarbons.

With reference to FIG. 11A, the basic operation of an ammonia-water absorption cycle is as follows: Heat (Qₘ) is applied to the generator, which contains a solution of water rich in ammonia. The heat causes high pressure ammonia vapor to desorb from the solution. Heat can either be from combustion of a fuel, such as clean-burning natural gas, or waste heat from engine exhaust, other industrial processes, solar heat, or any other heat source. The high pressure ammonia vapor flows to a condenser, typically cooled by outdoor air (Qₒᵤₜ). The ammonia vapor condenses into a high pressure liquid, releasing heat which can be used for product heat, such as space heating.

The high pressure ammonia liquid goes through a restriction to the low pressure side of the cycle. This liquid, at low pressures, boils or evaporates in the evaporator. This provides the cooling or refrigeration product. The low pressure vapor flows to the absorber, which contains a water-rich solution obtained from the generator. This solution absorbs the ammonia while releasing the heat of absorption. This heat can be used as product heat or for internal heat recovery in other parts of the cycle, thus unloading the burner and increasing cycle efficiency. The solution in the absorber, now once again rich in ammonia, is pumped to the generator, where it is ready to repeat the cycle.

FIG. 11B depicts a vapor absorption cycle as embodied in a membrane module 1110 in accordance with one or more embodiments of the invention. As shown, a first stream 1148 including, for example, water and ammonia (i.e., the generator) is introduced to the module 1110 between a heat exchange membrane 1114 and a contact membrane 1112 at a high pressure. A second stream 1150, for example, steam (i.e., the heat), can be introduced to the module 1150 on the other side of the heat exchange membrane 1114 causing the ammonia vapor to desorb the solution. The ammonia vapor passes through the contact membrane 1112. The high pressure ammonia vapor flows along another heat exchange membrane 1114 where it is cooled by a third stream 1152, for example, cooling water (i.e., the condenser) introduced to the module 1110 on the other side of the second heat exchange membrane 1114. The ammonia vapor condenses into a high pressure liquid, releasing heat.

The high pressure ammonia liquid can go through a restriction R, either formed within the membrane module (for example, a reduced opening in one of the membrane plates) or an external valve, to a low pressure side of the cycle. This liquid, at low pressures, boils or evaporates, providing cooling. The low-pressure ammonia vapor can be returned/maintained within the module 1110 where it can go through an absorption cycle. In one embodiment, the low pressure ammonia vapor is introduced to another channel of the module 1110 on one side of another contact membrane 1112. On the other side of the second contact membrane 1112 is the now water rich first stream 1148′, which absorbs the ammonia vapor through the membrane 1112. This solution, now once again rich in ammonia, can be returned to the second/generator channel of the module 1110, where it is ready to repeat the cycle. The now heated stream 1152 can be returned to, for example, a chiller or used in another industrial process as stream 1152′. The now depleted heat source, stream 1150, can be returned to a boiler or used in another industrial process as stream 1150′. The foregoing membrane vapor absorption cycle was described with respect to a combined membrane module in accordance with one or more embodiments of the invention; however, the membrane vapor absorption cycle could be carried out with separate membrane modules interconnected by any suitable means, for example, PVC piping. In addition, the foregoing module 1110, along with any of the membrane modules described herein, can be used with a controller for adjusting or regulating various aspects of the systems incorporating the modules.

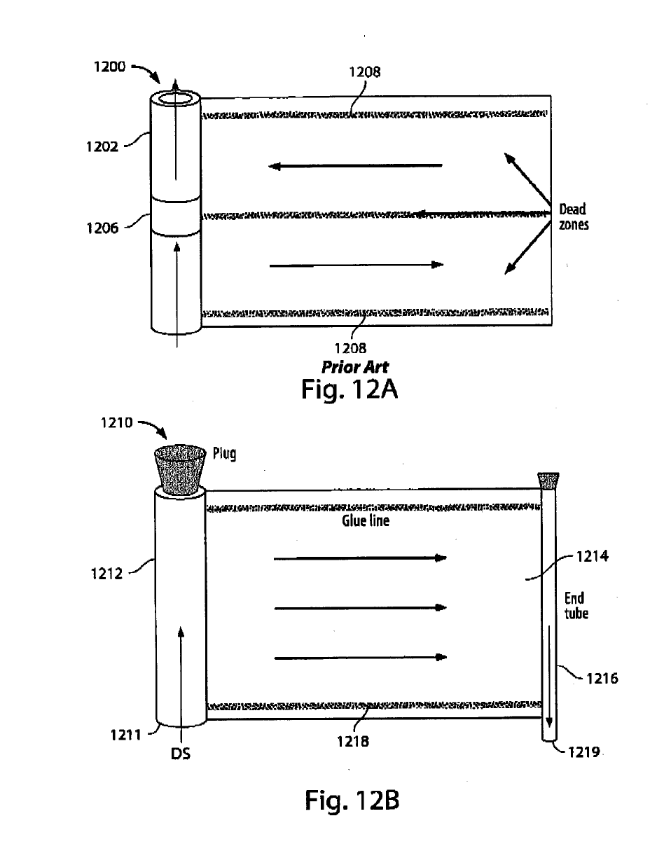

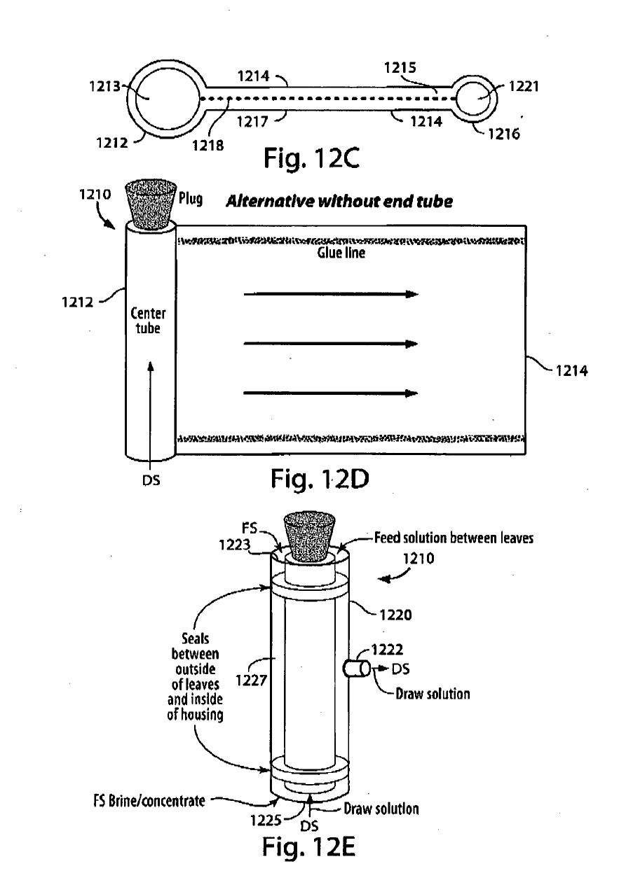

FIG. 12A depicts a prior art configuration of a spiral wound membrane module 1200. The module 1200 includes a center tube 1202 and one or more layers of membrane material 1204, where the center tube 1202 includes a plug 1206 centrally disposed therein and corresponding with a glue line 1208 along the membrane 1204. The plug 1206 and glue line 1208 act to force a fluid (e.g., a draw solution DS) out of the center tube 1202 and along a predetermined flow path through the membrane 1204, and back into the center tube 1202. The fluid DS enters one end of the center tube 1202 and exits the other end thereof. This arrangement results in a number of dead zones within the membrane module 1200.

FIGS. 12B-12E depict a forward osmosis cross-flow membrane module 1210 that eliminates the need for a plug within the center tube and results in a radial flow of a fluid DS from the center tube 1212 to the end of one or more membranes 1214. FIGS. 12B and 12C depict one embodiment of the membrane module 1210 in an unwound configuration. As shown, the center tube 1212 is open on only one end (inlet 1211) of its elongate body, either as manufactured or as a standard tube modified by plugging or capping one end, with its interior lumen 1213 in fluid communication with one side of the membranes 1214. The inlet 1211 can be threaded, flanged or otherwise configured for interconnection with other system components. In the embodiment shown, there are two membranes 1214 with a spacer 1218 disposed therebetween, the entire assembly sealed along its opposing sides to define an inner surface 1215 and an outer surface 1217. Depending on its intended use, either the feed sides or the permeate sides of the membranes are facing one another when assembled. The other end of the membrane assembly 1214, 1218 is in fluid communication with an end tube 1216 that is structurally similar to the center tube 1212 having an elongate body defining a lumen 1221 and an outlet 1219. This arrangement allows a raw solution DS entering the center tube 1212 to flow radially outward therefrom and between the two membranes 1214. The draw solution DS then enters the end tube 1216, where it is directed to the outlet 1219 disposed on one or both ends thereof. The module 1210 can be placed in a housing with appropriate porting to introduce a second fluid (e.g., feed solution FS) to the opposite sides of the membranes 1214. (See, for example, FIG. 12E).

FIG. 12D depict an alternative embodiment of the membrane module 1210, where the end tube is eliminated and the draw solution DS flows out of the ends of the membrane assembly 1214, 1218 and, for example, into a housing 1220, as shown in FIG. 12E. Referring to FIG. 12E, the wound membrane module 1210 is disposed within a chamber 1227 defined by the housing 1220, which has the necessary ports and seals to direct a draw solution DS and a feed solution FS through the housing 1220 and across the membrane surfaces 1215, 1217. As shown, the draw solution DS enters one end of the housing 1220 and center tube 1212, where it flows radially outward and along the membranes 1214 and out of a side port 1222 disposed in the housing 1220 as a dilute draw solution. The membrane module 1210 is sealed within the housing 1220 at both ends, such that the ends of the housing define bulkheads where the feed solution can be introduced between the wound membrane 1214 at one end (via inlet 1223) and exit the membrane module 1210 at the opposing end (via outlet 1225) as a concentrated solution. Alternatively, the feed solution can be introduced via the center tube 1212 and the draw solution can be introduced via the housing 1220.

Those skilled in the art should appreciate that the parameters and configurations described herein are exemplary and that actual parameters and/or configurations will depend on the specific application in which the various embodiments of the invention are used. Those skilled in the art should also recognize or be able to ascertain, using no more than routine experimentation, equivalents to the specific embodiments of the invention. It is, therefore, to be understood that the embodiments described herein are presented by way of example only and that, within the scope of the appended claims and equivalents thereto; the invention may be practiced otherwise than as specifically described.

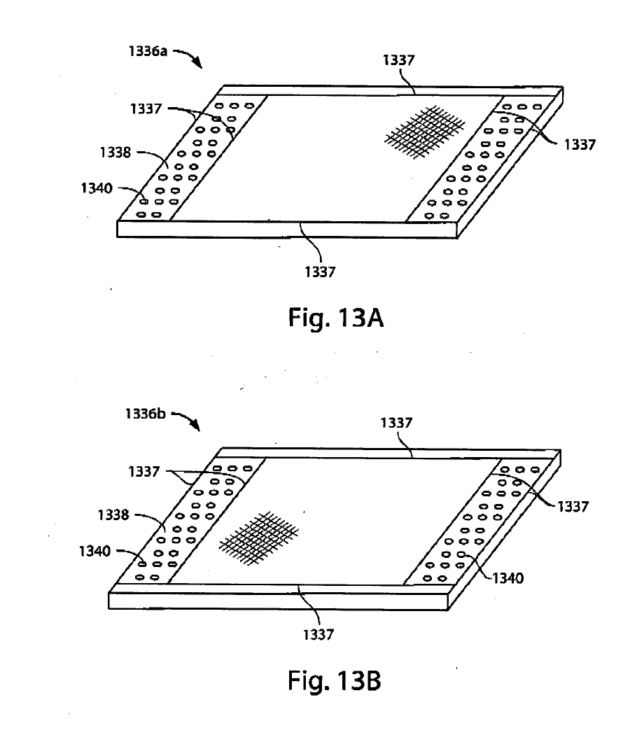

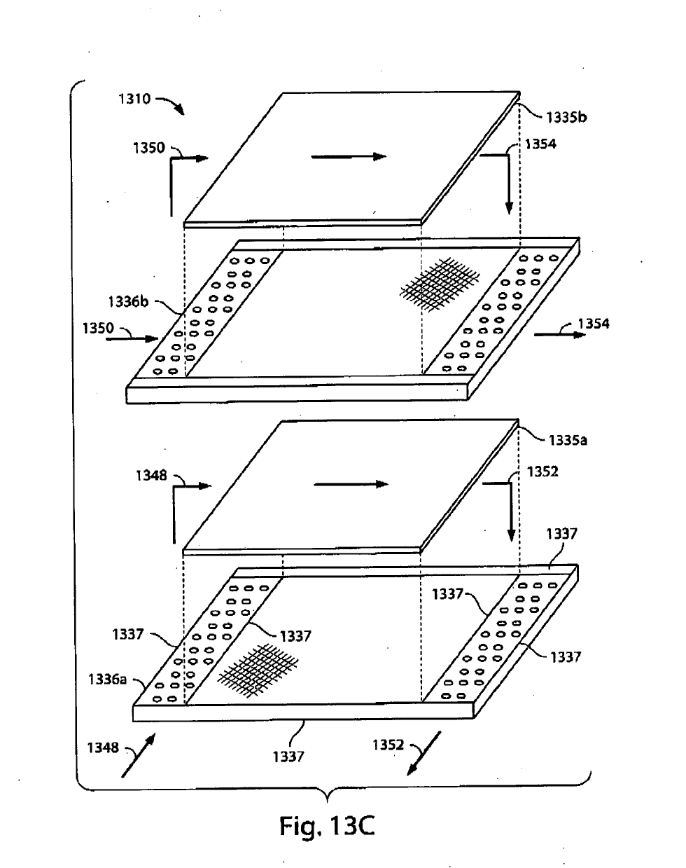

FIGS. 13A-13C depict an alternative membrane module and a method of manufacturing same. The structure of the module 1310 is similar to the types of construction previously described and is essentially a plurality of alternating layers of membranes and mesh sheets without the use of separate plates. FIG. 13A depicts a first mesh sheet 1336a on which a glue line(s) 1337 is disposed on its top surface to define a flow path across the mesh sheet 1336a. In one embodiment, there is no glue line on the bottom surface of the mesh sheet 1336a. In some embodiments, the mesh sheet 1336a can include solid end regions1338, which may include spacers 1340 disposed on either the top or bottom surface to provide additional spacing between layers. FIG. 13B depicts a second mesh sheet 1336b that has a similar construction as the first mesh sheet 1336a, but with a different flow path defined by the glue lines 1337. The glue lines 1337 on the second mesh sheet 1336b define a flow path having an inlet and an outlet corresponding to the ends of the mesh sheet 1336a. The glue lines 1337 on the first membrane sheet 1336ab define a flow path having an inlet and an outlet corresponding to the sides of the mesh sheet 1336b proximate the ends thereof. The glue lines 1337 can be manually applied or the process can be automated. In one embodiment, the glue lines 1337 can be preprinted onto the various mesh sheets. A membrane sheet 1335 can be attached to each mesh sheet 1336 (see FIG. 13C) via a portion of the glue lines 1337. Typically, the membrane sheet 1335 will be generally centrally located and sized to completely cover the “open” area of the mesh sheet 1336 and be sealed thereto to prevent the passage of any fluid trough the mesh unless it passes through the membrane. Alternatively or additionally, the membrane sheets 1335 can be attached to the mesh sheets 1336 via ultrasonic welding. As shown in the figures, the mesh and membrane sheets 1336, 1335 are generally rectangular in shape; however, other shapes are contemplated and considered within the scope of the invention.

FIG. 13C depicts the basic assembly of a portion of a membrane module 1310 in accordance with one embodiment of the invention. Generally, construction of the module begins with a first substrate, for example, the first mesh sheet 1336a; however, a separate substrate may be used as a base for assembling the module 1310 with the first mesh sheet 1336a attached thereto. The first mesh sheet 1336a can be secured to the substrate, if used, about its periphery. A first membrane sheet 1335a having a configuration (e.g., size and shape) that corresponds to that of the mesh sheet 1336a is disposed on the sheet 1336a and sealed (e.g., via glue or ultrasonic welding) along its periphery to the mesh sheet 1336a. This arrangement forces a first stream 1348 (for example a feed solution) introduced at one end of the module to flow over the membrane as it passes along the first mesh sheet/membrane sheet assembly (e.g., along the length of the exposed feed side of the membrane). A target solvent is free to pass through the membrane.

The second mesh sheet 1336b is then disposed on to the first mesh and membrane sheets 1336a, 1335a and sealed at its ends, along the entire length of one longitudinal side of the first mesh sheet 1336, and along a portion of the length of the opposite longitudinal side, as defined by the glue lines 1337, and forms a “pocket” that defines the aforementioned flow path for the first process stream 1348. Two different glue line patterns (i.e., flow paths) are shown; however, any number of glue patterns are possible to accommodate any number of streams to suit a particular application.

A second membrane sheet 1335b is then disposed on to the second mesh sheet 1336b and sealed about its periphery thereto. The second membrane sheet 1335b is arranged so that its feed side faces the feed side of the first membrane sheet 1335a. Alternatively, depending on the orientation of the first membrane sheet 1335a, the permeate side of the second membrane sheet 133b can be oriented to face the permeate side of the first membrane sheet 1335a. For example, in a membrane module used for forward osmosis, the feed and permeate sides of the adjacent membranes are oriented to face one another in an alternating manner. The previously mentioned spacers 1340, whether disposed on the bottom of the second mesh sheet 1336b or the top of the first mesh sheet 1336a, act as stand-offs and provide additional spacing between the mesh sheets. A third mesh sheet/membrane sheet assembly will be disposed on the second mesh sheet 1336 and attached thereto along the glue lines 1337 disposed on the top surface of the second mesh sheet 1336b, thereby forming another pocket/flow path for a second stream 1350 (for example, a draw solution) to pass through the openings along the unsealed ends between the second and third membrane sheets. In operation as a forward osmosis membrane module, the first stream 1348 enters the module as, for example, a feed solution and exits as a third stream 1352 in the form of a concentrated feed solution. The second stream 1350 enters the module as, for example, a draw solution and exits as a fourth stream 1354 in the form of a dilute draw solution.

The process of assembling mesh sheets 1336 and membrane sheets 1335 continues to produce the desired number of layers and pockets/flow paths therebetween. Alternatively, the membrane sheets can be attached to the mesh sheets prior to assembly. For example, a plurality of mesh sheet/membrane sheet assemblies can be preassembled for ease of manufacture and can be stocked for readily producing custom membrane modules. The assembled modules can then be disposed within a housing having suitable corresponding porting, as previously described.

The mesh sheets/membrane sheets are described as assembled in a planar manner however, the finished module may be oriented such the then membranes are aligned vertically on their longitudinal sides to, for example, better distribute the weight of the assembly. Additionally, the various membrane and mesh assemblies can be produced as sub-assemblies and finally assembled and stacked vertically to prevent the bottom layers from being crushed by the weight of the numerous membranes and mesh layers. Additionally, the assembled mesh and membrane sheets can be trimmed after assembly to provide a better interface within the housing.

The size and number of mesh and membrane sheets (layers) will be selected to suit a particular application, in particular to produce a specific total membrane surface area. In one embodiment, the module has an overall size of about 1 meter wide, about 10 meters long, and about 1 meter high. In the case of using 250 μm thick mesh/membrane sheet assemblies, approximately 4000 assemblies can be stacked in the 1 meter height, resulting in approximately 40,000 m² surface area. The flux rate will vary depending on the membrane parameters and the flow rates of the feed and draw solutions.

What is claimed is:

1. A membrane module comprising:
a plurality of first membrane plates, each plate comprising:
an interlocking mechanism disposed about at least a portion of a periphery thereof and defining an inlet, an outlet, and a flow path therebetween; and
a planar surface defining an opening formed therein;
a plurality of second membrane plates, each plate comprising:
an interlocking mechanism disposed about at least a portion of a periphery thereof and defining an inlet, an outlet, and a flow path therebetween; and
a planar surface defining an opening formed therein;
a plurality of membrane sheets, each sheet disposed on the planar surface of each of the first and second membrane plates and corresponding to the openings formed therein, wherein the plurality of first and second membrane plates are secured to one another via their interlocking mechanisms and arranged in an alternating pattern;
a first cover plate disposed below the assembled membrane plates and secured to at least one of the membrane plates; and
a second cover plate disposed above the assembled membrane plates and secured to at least one of the membrane plates.

2. (canceled)

3. The membrane module of claim 1, further comprising at least one manifold assembly secured to the assembled membrane plates to direct at least two process streams into and out of the membrane module via the first and second inlets and outlets.

4. The membrane module of claim 3, wherein the at least one manifold assembly comprises:
a first manifold assembly disposed on at least one of the cover plates and in fluid communication with the first and second inlets of the membrane plates; and
a second manifold assembly disposed on at least one of the cover plates and in fluid communication with first and second outlets of the membrane plates.

5. The membrane module of claim 1, further comprising a housing comprising first and second inlets and first and second outlets, wherein the membrane module is disposed within the housing such that the first inlet and the first outlet of the housing are in fluid communication with the first membrane plate inlets and the first membrane plate outlets and the second inlet and the second outlet of the housing are in fluid communication with the second membrane plate inlets and the second membrane plate outlets.

6. The membrane module of claim 1 further comprising a plurality of mesh sheets disposed between adjacent membrane plates.

7. The membrane module of claim 1, wherein the first and second cover plates are secured to one another via mechanical fasteners.

8. The membrane module of claim 1, wherein each of the plurality of membrane plates comprises a polymeric material.

9. The membrane module of claim 1, wherein the plurality of membrane sheets comprises forward osmosis membranes.

10. The membrane module of claim 9, wherein each of the forward osmosis membranes comprises a feed side and a permeate side and are oriented on the membrane plates such that for any two adjacent membrane plates, either the permeate sides are facing each other or the feed sides are facing each other.

11. The membrane module of claim 1, wherein the plurality of membrane sheets comprises a plurality of heat exchange membranes and a plurality of contact membranes.

12. The membrane module of claim 11, wherein the plurality of heat exchange membranes are disposed on the plurality of first membrane plates and the plurality of contact membranes are disposed on the plurality of second membrane plates.

13. (canceled)

14. The membrane module of claim 1, wherein the plurality of membrane sheets comprises at least one of an evaporator membrane, a condenser membrane, an absorber membrane, and a heat exchange membrane.

15. The membrane module of claim 1, wherein each of the first and second membrane plates comprises a top surface and a bottom surface and the respective interlocking mechanisms are disposed on both the top and bottom surfaces of each membrane plate.

16. A spiral wound membrane module comprising:
a center tube having an elongate body defining an inlet and an inner lumen;
a membrane assembly defining an inner surface and an outer surface, wherein the inner surface is in fluid communication with the inner lumen of the center tube;
an end tube having an elongate body defining an outlet and an inner lumen, wherein the inner lumen of the end tube is in fluid communication with the inner surface of the membrane assembly; and
a housing comprising an inlet and an outlet and defining a chamber for receiving the center tube, the membrane assembly, and the end tube, wherein the chamber is in fluid communication with the outer surface of the membrane assembly and is in fluidic isolation from the center tube inlet and the end tube outlet.

17. A membrane module comprising:
a plurality of first membrane plates, each defining an inlet, an outlet, and an opening formed in a planar surface thereof;
a plurality of heat exchange membranes, each secured to one of the plurality of first membrane plates and oriented to cover the opening formed in the planar surface thereof;
a plurality of second membrane plates, each defining an inlet, an outlet, and an opening formed in a planar surface thereof; and
a plurality of contact membranes, each secured to one of the plurality of second membrane plates and oriented to cover the opening formed in the planar surface thereof; wherein the first and second membrane plates are assembled in an alternating manner.

18. The membrane module of claim 17, wherein the first membrane plate inlets are in fluid communication.

19. The membrane module of claim 17, wherein the first membrane plate outlets are in fluid communication.

20. The membrane module of claim 17, wherein the second membrane plate inlets are in fluid communication.

21. The membrane module of claim 17, wherein the second membrane plate outlets are in fluid communication.
